(19) United States
(12) Patent Application Publication
(10) Pub. No.: US 2023/0214636 A1
(43) Pub. Date: Jul. 6, 2023

(54) DAG MODIFICATION MODULE, PROCESSING DEVICE INCLUDING SAME, AND DAG MODIFICATION METHOD OF PROCESSING DEVICE

(71) Applicant: Rebellions Inc., Seongnam-si (KR)

(72) Inventor: Jaehwan Lee, Seongnam-si (KR)

(21) Appl. No.: 18/061,100

(22) Filed: Dec. 2, 2022

(30) Foreign Application Priority Data
Dec. 30, 2021 (KR) 10-2021-0192184

(51) Int. Cl. G06N 3/063; G06N 3/08; G06N 3/0464; G06F 16/901

(52) U.S. Cl. CPC G06N 3/063; G06N 3/08; G06N 3/0464; G06F 16/9024

(57) ABSTRACT

A DAG modification module, a processing device including the same, and a DAG modification method of the processing device are provided. The DAG modification module comprises an identification module configured to receive a directed acyclic graph (DAG) as an input, identify sub-graphs including non-unit operations that are not predefined unit operations out of the DAG, and replace the sub-graphs with transformed sub-graphs to thereby generate a transformed DAG, a transform module configured to receive the sub-graphs including the non-unit operations, transform the sub-graphs into the transformed sub-graphs including the unit operations, and transfer the transformed sub-graphs to the identification module, a unit operation database configured to provide a unit operation list in which the unit operations are recorded to the identification module, and an optimization module configured to receive the transformed DAG, receive a calculation method table for each of the unit operations from the unit operation database.

### CROSS-REFERENCE TO RELATED APPLICATION

This application claims priority under 35 U.S.C § 119 to Korean Patent Application No. 10-2021-0192184 filed in the Korean Intellectual Property Office on Dec. 30, 2021, the entire contents of which are hereby incorporated by reference.

### TECHNICAL FIELD

The disclosure relates to a DAG modification module, a processing device including the same, and a DAG modification method of the processing device. More particularly, the disclosure relates to, for example, but not limited to, a DAG modification module for modifying a directed acyclic graph (DAG) created by a deep-learning framework, a processing device including the same, and a DAG modification method of the processing device.

### BACKGROUND

For the last few years, artificial intelligence technology has been the core technology of the Fourth Industrial Revolution and the subject of discussion as the most promising technology worldwide. The biggest problem with such artificial intelligence technology is computing performance. For artificial intelligence technology which realizes human learning ability, reasoning ability, perceptual ability, natural language implementation ability, etc., it is of utmost important to process a large amount of data quickly.

For deep-learning training and inference in artificial intelligence, not only central processing units (CPUs) or graphics processing units (GPUs) of off-the-shelf computers but also neural processing units (NPUs) that are structurally specialized for the tasks of deep-learning training and inference with high workloads have been used.

The deep-learning tasks and neural network models processed by such various processing devices are mainly provided in the form of DAGs created using deep-learning frameworks. The DAG refers to a directed acyclic graph, i.e., a graph organized in a structure in which individual elements are oriented in particular directions and do not circulate each other.

In the case of such DAGs, a same function may be expressed in various representations, and optimal performance may not be achieved when each representation is implemented in a different way.

The description set forth in the background section should not be assumed to be prior art merely because it is set forth in the background section. The background section may describe aspects or embodiments of the disclosure.

### SUMMARY

Aspects of the disclosure provide a DAG modification module that maximizes hardware efficiency by appropriately modifying the DAG.

Aspects of the disclosure provide a processing device that maximizes hardware efficiency by appropriately modifying the DAG.

Aspects of the disclosure to provide a DAG modification method of a processing device that maximizes hardware efficiency by appropriately modifying the DAG.

According to some aspects of the disclosure, a DAG modification module comprises: an identification module configured to receive a directed acyclic graph (DAG) as an input, identify sub-graphs including non-unit operations that are not predefined unit operations out of the DAG, and replace the sub-graphs with transformed sub-graphs to thereby generate a transformed DAG; a transform module configured to receive the sub-graphs including the non-unit operations, transform sub-graphs into the transformed sub-graphs including the unit operations, and transfer the transformed sub-graphs to the identification module; a unit operation database configured to provide a unit operation list in which the unit operations are recorded to the identification module; and an optimization module configured to receive the transformed DAG, receive a calculation method table for each of the unit operations from the unit operation database, and determine calculation methods for the unit operations of the transformed DAG to thereby generate an optimized DAG.

According to some aspects, the DAG represents a deep-learning task with nodes and edges.

According to some aspects, the unit operation list is updatable.

According to some aspects, each of the unit operations is an atomic operation that cannot be decomposed any further.

According to some aspects, the transform module partitions the non-unit operations into the unit operations and thereby generates the transformed sub-graphs.

According to some aspects, the unit operations are generated by sequentially combining a plurality of partition operations.

According to some aspects, the transform module generates the transformed sub-graphs by partitioning the non-unit operations into the unit operations or by combining the non-unit operations into the unit operations.

According to some aspects, the unit operations comprise a convolution operation comprising padding and bias functions.

According to some aspects, a first partition operation of the plurality of partition operations comprises a padding operation, and a second partition operation of the plurality of partition operations comprises a convolution operation comprising a bias function.

According to some aspects, the unit operations are generated by sequentially combining a first partition operation and a second partition operation of the plurality of partition operations with a third partition operation of the plurality of partition operations, the first partition operation comprises a padding operation, the second partition operation comprises a convolution operation, and the third partition operation comprises a bias-add operation.

According to some aspects of the disclosure, a processing device comprises: at least one processor comprising at least one neural core; and at least one memory configured to store data of the at least one processor, wherein a compiler stack implemented by the at least one processor comprises: an adaptation layer configured to receive a DAG, transform the DAG in accordance with hardware, and quantize the transformed DAG to generate a quantized model; a front-end compiler configured to receive the quantized model and transform the quantized model into an intermediate representation; and a back-end compiler configured to receive the intermediate representation and transform the intermediate representation into at least one binary code, wherein the adaptation layer comprises a DAG modification module configured to receive the DAG and generate an optimized DAG using preset unit operations, and the unit operations are at least one of several operations capable of representing sub-graphs of the DAG.

According to some aspects, the unit operations are predefined operations.

According to some aspects, each of the at least one neural core comprises: a local memory exclusively used by each of the at least one neural core; and an activation buffer configured to temporarily store input activations and output activations.

According to some aspects, each of the at least one neural core further comprises: a processing unit configured to receive the input activations, perform calculations with the input activations, and thereby output the output activations, and wherein the processing unit comprises: a PE array configured to perform two-dimensional multiplication calculations; and a vector unit configured to perform one-dimensional calculations.

According to some aspects, the processing device further comprises: a local interconnection configured to transmit data between the at least one neural core; and an L2 sync path configured to transmit synchronization signals between the at least one neural core.

According to some aspects, the DAG modification module comprises: an identification module configured to receive the DAG as an input, identify sub-graphs including non-unit operations out of the DAG using a unit operation list, and replace the sub-graphs with transformed sub-graphs to thereby generate a transformed DAG; a transform module configured to receive the sub-graphs including the non-unit operations, transform the sub-graphs into the transformed sub-graphs including the unit operations, and transfer the transformed sub-graphs to the identification module; and an optimization module configured to receive the transformed DAG, and determine calculation methods for the unit operations of the transformed DAG to thereby generate an optimized DAG.

According to some aspects, the DAG modification module further comprises a unit operation database configured to provide the unit operation list to the identification module.

According to some aspects, the unit operations are set to suit structural characteristics of the at least one neural core.

According to some aspects of the disclosure, a DAG modification method of a processing device, comprising: receiving a DAG including at least one sub-graph, wherein the sub-graph comprises at least one operation; identifying whether the operation is a unit operation; generating a transformed DAG by replacing the sub-graph including a non-unit operation that is not the unit operation with a transformed sub-graph including the unit operation; and generating an optimized DAG by defining a calculation method for the unit operation of the transformed DAG.

According to some aspects, the identifying whether the operation is a unit operation comprises: receiving a unit operation list; and comparing the unit operation list with the operation.

According to some aspects, the generating an optimized DAG comprises: receiving a calculation method table; and generating the optimized DAG by defining a calculation method according to the calculation method table.

According to some aspects, the DAG is created with a deep-learning framework.

According to some aspects of the disclosure, a DAG modification method of a processing device, comprising: setting a unit operation list by predefining unit operations; defining calculation methods for the unit operations and writing the calculation methods in a calculation method table; receiving a DAG created with a deep-learning framework; identifying non-unit operations that are not the unit operations out of operations of the DAG; transforming the non-unit operations into the unit operations; and determining the calculation methods for the unit operations.

According to some aspects, the unit operations are set according to hardware characteristics.

According to some aspects, the DAG comprises a first operation, the first operation comprises a first function and a second function of a plurality of functions, wherein the first and second functions are atomic operation functions that cannot be partitioned any further, and the unit operations comprise at least one of the first function or the second function.

According to some aspects, the unit operations comprise at least one of add, subtraction, multiplication, division, square root, padding, bias-add, or convolution.

According to some aspects, the determining calculation methods comprises: identifying a first constant inputted in the unit operations; and deriving a second constant by performing calculation with the first constant, wherein the second constant is a final value that cannot be calculated any further.

According to some aspects, the DAG modification method further comprises: generating an optimized DAG for which the calculation methods have been determined; and generating a quantized model by quantizing the optimized DAG.

According to some aspects, the DAG modification method further comprises: transforming the quantized model into an intermediate representation.

According to some aspects, the DAG modification method further comprises: generating at least one binary code through the intermediate representation.

Aspects of the disclosure are not limited to those mentioned above, and other objects and advantages of the disclosure that have not been mentioned can be understood by the following description, and will be more clearly understood by embodiments of the disclosure. In addition, it will be readily understood that the objects and advantages of the disclosure can be realized by the means and combinations thereof set forth in the claims.

The DAG modification module, the processing device including the same, and the DAG modification method of the processing device of the disclosure can modify the DAG capable of various representations into the most efficient representation and maximize the efficiency of subsequent hardware tasks.

In addition, it is possible to derive optimal task efficiency by updating the definition of the unit operations and changing the operation methods according to the tasks.

In addition to the foregoing, the specific effects of the disclosure will be described together while elucidating the specific details for carrying out the embodiments below.

### BRIEF DESCRIPTION OF THE DRAWINGS

FIG. 1 is a block diagram for illustrating a processing system in accordance with some embodiments of the disclosure;

FIG. 2 is a block diagram for illustrating the processing device of FIG. 1 in detail;

FIG. 3 is a block diagram for illustrating the neural core SoC of FIG. 2;

FIG. 4 is a structural diagram for illustrating the global interconnection of FIG. 3;

FIG. 5 is a block diagram for illustrating the neural processor of FIG. 3;

FIG. 6 is a block diagram for illustrating the neural core of FIG. 5;

FIG. 7 is a block diagram for illustrating the LSU of FIG. 6;

FIG. 8 is a block diagram for illustrating the processing unit of FIG. 6;

FIG. 9 is a block diagram for illustrating the local memory of FIG. 6;

FIG. 10 is a block diagram for illustrating the local memory bank of FIG. 9;

FIG. 11 is a block diagram for illustrating memory reconstruction of a processing system in accordance with some embodiments of the disclosure;

FIG. 12 is a block diagram showing an example of memory reconstruction of a processing system in accordance with some embodiments of the disclosure;

FIG. 13 is an enlarged block diagram of a portion A of FIG. 11;

FIG. 14 is a diagram for illustrating the first bank of FIG. 13;

FIG. 15 is a block diagram for illustrating a software hierarchy of a processing device in accordance with some embodiments of the disclosure;

FIG. 16 is a conceptual diagram for illustrating deep-learning calculations performed by a processing device in accordance with some embodiments of the disclosure;

FIG. 17 is a conceptual diagram for illustrating training and inference operations of a neural network of a processing device in accordance with some embodiments of the disclosure;

FIG. 18 is a block diagram for illustrating in detail the structure of the adaptation layer of FIG. 15;

FIG. 19 is an example diagram for illustrating the DAG of FIG. 18;

FIG. 20 is a block diagram for illustrating in detail the DAG modification module of FIG. 18;

FIG. 21 is a conceptual diagram for illustrating the unit operation list of FIG. 20;

FIG. 22 is a diagram for illustrating the identification of non-unit operations of the DAG;

FIG. 23 is a conceptual diagram showing various implementation examples of sub-graphs;

FIG. 24 is a diagram for illustrating the definition of a Rectified Linear Unit (ReLU) function;

FIG. 25 is an example diagram for illustrating various representations of ReLU operations;

FIG. 26 is an example diagram for illustrating the transformed DAG of FIG. 20;

FIG. 27 is an example diagram for illustrating one representation of a calculation method for a batch normalize operation;

FIG. 28 is an example diagram for illustrating one representation of a calculation method for a batch normalize operation through constant calculation;

FIG. 29 is a flowchart for illustrating a DAG modification method of a processing device in accordance with some embodiments of the disclosure; and

FIG. 30 is a flowchart for illustrating in detail the identifying sub-graphs of FIG. 29.

### DETAILED DESCRIPTION OF THE PREFERRED EMBODIMENTS

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own embodiments in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are used only for the purpose of distinguishing one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular expressions include plural expressions unless the context explicitly indicates otherwise. In the application, terms such as “comprise,” “have,” “include”, “contain,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless otherwise defined, all terms used herein, including technical or scientific terms, have the same meaning as commonly understood by those of ordinary skill in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the disclosure.

In addition, each configuration, procedure, process, method, or the like included in each embodiment of the disclosure may be shared to the extent that they are not technically contradictory to each other.

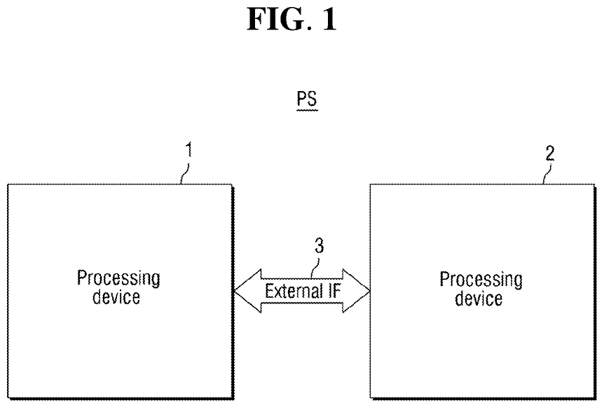

Hereinafter, a processing device in accordance with some embodiments of the disclosure will be described with reference to FIGS. 1 to 28.

FIG. 1 is a block diagram for illustrating a processing system in accordance with some embodiments of the disclosure.

With reference to FIG. 1, a processing system PS in accordance with some embodiments of the disclosure may include a first processing device 1, a second processing device 2, and an external interface 3.

The first processing device 1 may be a device that performs calculations using an artificial neural network. The first processing device 1 may be, for example, a device specialized in performing the tasks of deep-learning calculations. However, the present embodiment is not limited thereto.

The second processing device 2 may be a device having the same or similar configuration as the first processing device 1. The first processing device 1 and the second processing device 2 may be connected to each other via the external interface 3 and share data and control signals.

Although FIG. 1 shows two processing devices, the processing system PS in accordance with some embodiments of the disclosure is not limited thereto. That is, in a processing system PS in accordance with some embodiments of the disclosure, three or more processing devices may be connected to one another via the external interface 3. Also, conversely, a processing system PS in accordance with some embodiments of the disclosure may include only one processing device.

In this case, the processing device may include a device based on at least one of a neural processing unit (NPU), a central processing unit (CPU), or a graphics processing unit (GPU) specialized for deep-learning tasks.

The processing device may include at least one processor. In addition, the processing device may include a memory for storing data to be processed by the processor. Hereinafter, the processing device, which is a neural processing unit by way of an example, will be described in detail.

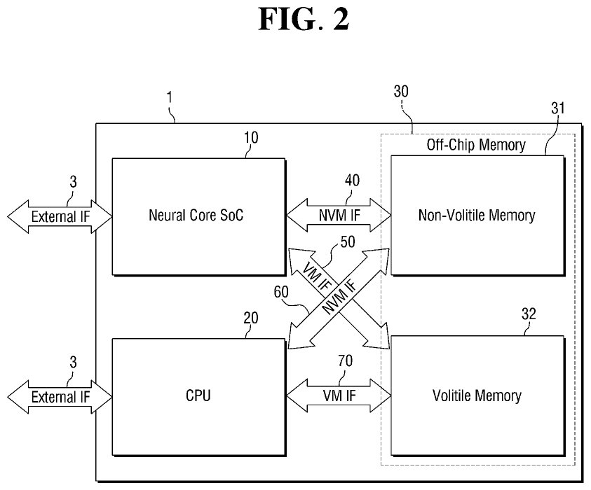

FIG. 2 is a block diagram for illustrating the processing device of FIG. 1 in detail.

With reference to FIG. 2, the first processing device 1 may include a neural core SoC 10, a CPU 20, an off-chip memory 30, a first non-volatile memory interface 40, a first volatile memory interface 50, a second non-volatile memory interface 60, and a second volatile memory interface 70.

The neural core SoC 10 may be a system on a chip device. The neural core SoC 10 is an artificial intelligence calculation device and may be an accelerator. The neural core SoC 10 may be, for example, but not limited to, any one of a graphics processing unit (GPU), a field-programmable gate array (FPGA), and an application-specific integrated circuit (ASIC).

The neural core SoC 10 may exchange data with other external calculation devices via the external interface 3. Further, the neural core SoC 10 may be connected to the non-volatile memory 31 and the volatile memory 32 via the first non-volatile memory interface 40 and the first volatile memory interface 50, respectively.

The CPU 20 may be a control device that controls the system of the first processing device 1 and executes program calculations. The CPU 20 is a general-purpose calculation device and may have low efficiency in performing simple parallel calculations that are used a lot in deep learning. Therefore, there can be high efficiency by performing calculations in deep-learning inference and training tasks by the neural core SoC 10.

The CPU 20 may exchange data with other external calculation devices via the external interface 3. In addition, the CPU 20 may be connected to the non-volatile memory 31 and the volatile memory 32 via the second non-volatile memory interface 60 and the second volatile memory interface 70, respectively.

The off-chip memory 30 may be a memory disposed outside the chip of the neural core SoC 10. The off-chip memory 30 may include a non-volatile memory 31 and a volatile memory 32.

The non-volatile memory 31 may be a memory that continuously retains stored information even if electric power is not supplied. The non-volatile memory 31 may include, for example, at least one of Read-Only Memory (ROM), Programmable Read-Only Memory (PROM), Erasable Alterable ROM (EAROM), Erasable Programmable Read-Only Memory (EPROM), Electrically Erasable Programmable Read-Only Memory (EEPROM) (e.g., NAND Flash memory, NOR Flash memory), Ultra-Violet Erasable Programmable Read-Only Memory (UVEPROM), Ferroelectric Random-Access Memory (FeRAM), Magnetoresistive Random-Access Memory (MRAM), Phase-change Random-Access Memory (PRAM), silicon-oxide-nitride-oxide-silicon (SONOS), Resistive Random-Access Memory (RRAM), Nanotube Random-Access Memory (NRAM), magnetic computer storage devices (e.g., hard disks, diskette drives, magnetic tapes), optical disc drives, or 3D XPoint memory. However, the embodiment is not limited thereto.

The volatile memory 32 may be a memory that continuously requires electric power to retain stored information, unlike the non-volatile memory 31. The volatile memory 32 may include, for example, at least one of Dynamic Random-Access Memory (DRAM), Static Random-Access Memory (SRAM), Synchronous Dynamic Random-Access Memory (SDRAM), or Double Data Rate SDRAM (DDR SDRAM). However, the embodiment is not limited thereto.

Each of the first non-volatile memory interface 40 and the second non-volatile memory interface 60 may include, for example, at least one of Parallel Advanced Technology Attachment (PATA), Small Computer System Interface (SCSI), Serial Attached SCSI (SAS), Serial Advanced Technology Attachment (SATA), or PCI Express (PCIe). However, the embodiment is not limited thereto.

Each of the first volatile memory interface 50 and the second volatile memory interface 70 may be, for example, at least one of SDR (Single Data Rate), DDR (Double Data Rate), QDR (Quad Data Rate), or XDR (eXtreme Data Rate, Octal Data Rate). However, the embodiment is not limited thereto.

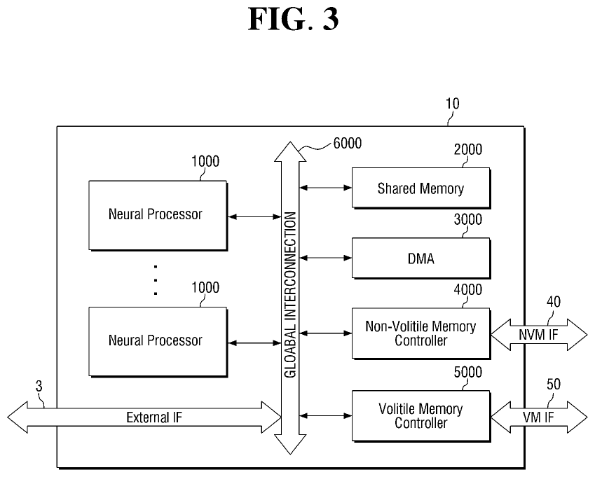

FIG. 3 is a block diagram for illustrating the neural core SoC of FIG. 2.

Referring to FIGS. 2 and 3, the neural core SoC 10 may include at least one neural processor 1000, a shared memory 2000, direct memory access (DMA) 3000, a non-volatile memory controller 4000, a volatile memory controller 5000, and a global interconnection 6000.

The neural processor 1000 may be a calculation device that directly performs calculation tasks. If there exist neural processors 1000 in plurality, calculation tasks may be assigned to respective neural processors 1000. The respective neural processors 1000 may be connected to each other via the global interconnection 6000.

The shared memory 2000 may be a memory shared by multiple neural processors 1000. The shared memory 2000 may store data of each neural processor 1000. In addition, the shared memory 2000 may receive data from the off-chip memory 30, store the data temporarily, and transfer the data to each neural processor 1000. On the contrary, the shared memory 2000 may also receive data from the neural processor 1000, store the data temporarily, and transfer the data to the off-chip memory 30 of FIG. 2.

The shared memory 2000 may need a relatively high-speed memory. Accordingly, the shared memory 2000 may include, for example, an SRAM. However, the embodiment is not limited thereto. That is, the shared memory 2000 may include a DRAM as well.

The shared memory 2000 may be a memory corresponding to the SoC level, i.e., level 3 (L3). Accordingly, the shared memory 2000 may also be represented as an L3 shared memory.

The DMA 3000 may directly control the movement of data without the need for the neural processor 1000 to control the input/output of data. Accordingly, the DMA 3000 may control the data movement between memories, thereby minimizing the number of interrupts of the neural processor 1000.

The DMA 3000 may control the data movement between the shared memory 2000 and the off-chip memory 30. Via the authority of the DMA 3000, the non-volatile memory controller 4000 and the volatile memory controller 5000 may perform the movement of data.

The non-volatile memory controller 4000 may control the task of reading from or writing onto the non-volatile memory 31. The non-volatile memory controller 4000 may control the non-volatile memory 31 via the first non-volatile memory interface 40.

The volatile memory controller 5000 may control the task of reading from or writing onto the volatile memory 32. Further, the volatile memory controller 5000 may perform a refresh task of the volatile memory 32. The volatile memory controller 5000 may control the volatile memory 32 via the first volatile memory interface 50.

The global interconnection 6000 may connect the at least one neural processor 1000, the shared memory 2000, the DMA 3000, the non-volatile memory controller 4000, and the volatile memory controller 5000 to one another. In addition, the external interface 3 may also be connected to the global interconnection 6000. The global interconnection 6000 may be a path through which data travels between the at least one neural processor 1000, the shared memory 2000, the DMA 3000, the non-volatile memory controller 4000, the volatile memory controller 5000, and the external interface 3.

The global interconnection 6000 may transmit not only data but also control signals and may transmit a signal for synchronization. That is, in the processing device in accordance with some embodiments of the disclosure, each neural processor 1000 may directly transmit and receive a synchronization signal, instead of a separate control processor managing the synchronization signal. Accordingly, it is possible to preclude the latency of the synchronization signal generated by the control processor.

In other words, if there exist neural processors 1000 in plurality, there may be dependencies of individual tasks in which the task of one neural processor 1000 needs to be finished before the next neural processor 1000 can start a new task. The end and start of these individual tasks can be checked via a synchronization signal, and in conventional techniques, a control processor performed the reception of such a synchronization signal and an instruction to start a new task.

However, as the number of neural processors 1000 increases and task dependencies are designed more complicatedly, the number of requests and instructions for this synchronization task has increased exponentially. Therefore, the latency resulting from each request and instruction can greatly reduce the efficiency of tasks.

Accordingly, in the processing device in accordance with some embodiments of the disclosure, each neural processor 1000, instead of the control processor, may directly transmit a synchronization signal to another neural processor 1000 according to the dependency of a task. In this case, multiple neural processors 1000 can perform the synchronization tasks in parallel as compared with the method managed by the control processor, thereby minimizing the latency due to synchronization.

Furthermore, the control processor needs to perform the task scheduling of the neural processors 1000 according to a task dependency, and the overhead of such scheduling may also increase significantly as the number of neural processors 1000 increases. Therefore, in the processing device in accordance with some embodiments of the disclosure, the scheduling task is also performed by the individual neural processors 1000, and thus, the performance of the device can be improved without even a scheduling burden resulting therefrom.

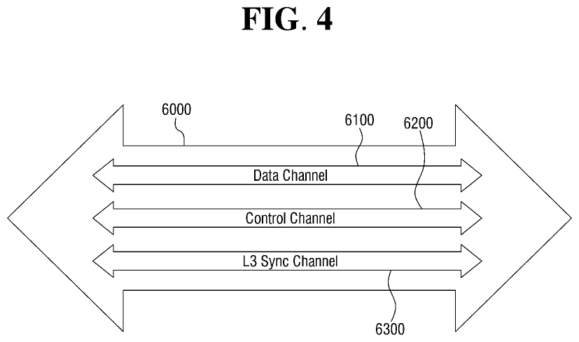

FIG. 4 is a structural diagram for illustrating the global interconnection of FIG. 3.

Referring to FIG. 4, the global interconnection 6000 may include a data channel 6100, a control channel 6200, and an L3 sync channel 6300.

The data channel 6100 may be a dedicated channel for transmitting data. Through the data channel 6100, the at least one neural processor 1000, the shared memory 2000, the DMA 3000, the non-volatile memory controller 4000, the volatile memory controller 5000, and the external interface 3 may exchange data with one another.

The control channel 6200 may be a dedicated channel for transmitting control signals. Through the control channel 6200, the at least one neural processor 1000, the shared memory 2000, the DMA 3000, the non-volatile memory controller 4000, the volatile memory controller 5000, and the external interface 3 may exchange control signals with one another.

The L3 sync channel 6300 may be a dedicated channel for transmitting synchronization signals. Through the L3 sync channel 6300, the at least one neural processor 1000, the shared memory 2000, the DMA 3000, the non-volatile memory controller 4000, the volatile memory controller 5000, and the external interface 3 may exchange synchronization signals with one another.

The L3 sync channel 6300 may be set as a dedicated channel inside the global interconnection 6000, and thus, may not overlap with other channels and transmit synchronization signals quickly. Accordingly, the processing device in accordance with some embodiments of the disclosure does not require new wiring work and may smoothly perform the synchronization task by utilizing the conventionally used global interconnection 6000.

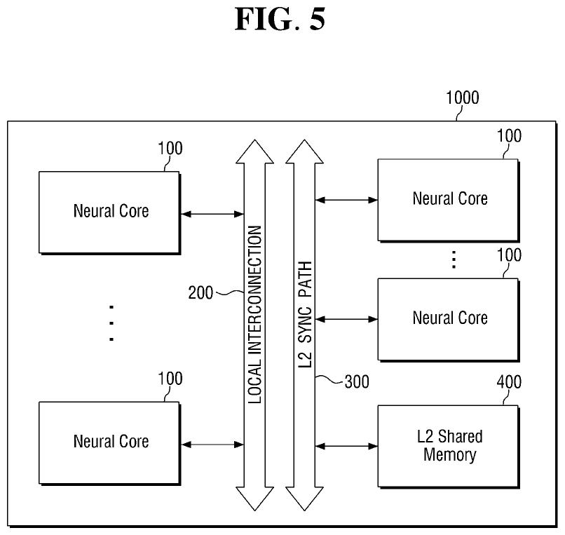

FIG. 5 is a block diagram for illustrating the neural processor of FIG. 3.

Referring to FIGS. 3 to 5, the neural processor 1000 may include at least one neural core 100, an L2 shared memory 400, a local interconnection 200, and an L2 sync path 300.

The at least one neural core 100 may share and perform the tasks of the neural processor 1000. The number of neural cores 100 may be, for example, eight. However, the embodiment is not limited thereto. FIGS. 4 and 5 illustrate that a plurality of neural cores are included in the neural processor 1000, but the embodiment is not limited thereto. That is, the neural processor 1000 may be configured with only one neural core.

The L2 shared memory 400 may be a memory shared by the neural cores 100 in the neural processor 1000. The L2 shared memory 400 may store data of each neural core 100. In addition, the L2 shared memory 400 may receive data from the shared memory 2000 of FIG. 3, store the data temporarily, and transfer the data to each neural core 100. On the contrary, the L2 shared memory 400 may also receive data from the neural core 100, store the data temporarily, and transfer the data to the shared memory 2000 of FIG. 3.

The L2 shared memory 400 may be a memory corresponding to the neural processor level, i.e., level 2 (L2). The L3 shared memory, i.e., the shared memory 2000 may be shared by the neural processors 1000, and the L2 shared memory 400 may be shared by the neural cores 100.

The local interconnection 200 may connect the at least one neural core 100 and the L2 shared memory 400 to each other. The local interconnection 200 may be a path through which data travels between the at least one neural core 100 and the L2 shared memory 400. The local interconnection 200 may be connected and transmit data to the global interconnection 6000 of FIG. 3.

The L2 sync path 300 may connect the at least one neural core 100 and the L2 shared memory 400 to each other. The L2 sync path 300 may be a path through which synchronization signals of the at least one neural core 100 and the L2 shared memory 400 travel.

The L2 sync path 300 may be formed physically separately from the local interconnection 200. In the case of the local interconnection 200, sufficient channels may not be formed therein, unlike the global interconnection 6000. In such a case, the L2 sync path 300 may be formed separately so that the synchronization signal can be transmitted quickly and without any delay. The L2 sync path 300 may be used for synchronization performed at a level one step lower than that of the L3 sync channel 6300 of the global interconnection 6000.

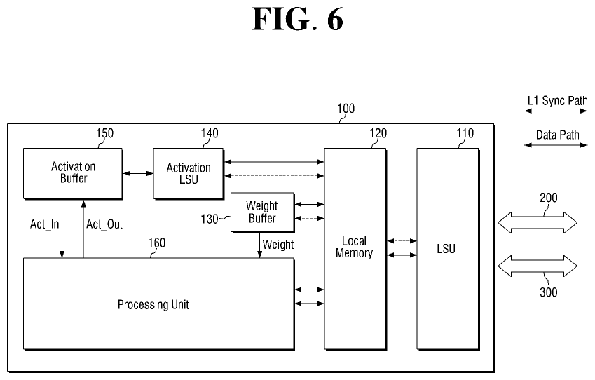

FIG. 6 is a block diagram for illustrating the neural core of FIG. 5.

Referring to FIG. 6, each of the at least one neural core 100 may include a load/store unit (LSU) 110, a local memory 120, a weight buffer 130, an activation LSU 140, an activation buffer 150, and a processing unit 160.

The LSU 110 may receive at least one of data, a control signal, or a synchronization signal from the outside via the local interconnection 200 and the L2 sync path 300. The LSU 110 may transmit at least one of the data, the control signal, or the synchronization signal received to the local memory 120. Similarly, the LSU 110 may transfer at least one of the data, the control signal, or the synchronization signal to the outside via the local interconnection 200 and the L2 sync path 300.

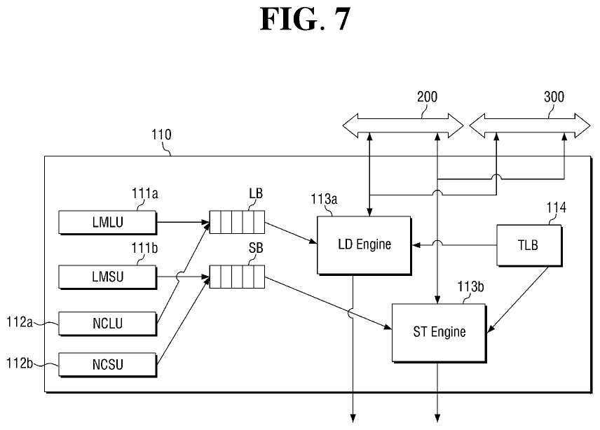

FIG. 7 is a block diagram for illustrating the LSU of FIG. 6.

Referring to FIG. 7, the LSU 110 may include a local memory load unit (LMLU) 111a, a local memory store unit (LMSU) 111b, a neural core load unit (NCLU) 112a, a neural core store unit (NCSU) 112b, a load buffer LB, a store buffer SB, a load (LD) engine 113a, a store (ST) engine 113b, and a translation lookaside buffer (TLB) 114.

The local memory load unit 111a may fetch a load instruction for the local memory 120 and issue the load instruction. When the local memory load unit 111a provides the issued load instruction to the load buffer LB, the load buffer LB may sequentially transmit memory access requests to the load engine 113a according to the inputted order.

Further, the local memory store unit 111b may fetch a store instruction for the local memory 120 and issue the store instruction. When the local memory store unit 111b provides the issued store instruction to the store buffer SB, the store buffer SB may sequentially transmit memory access requests to the store engine 113b according to the inputted order.

The neural core load unit 112a may fetch a load instruction for the neural core 100 and issue the load instruction. When the neural core load unit 112a provides the issued load instruction to the load buffer LB, the load buffer LB may sequentially transmit memory access requests to the load engine 113a according to the inputted order.

In addition, the neural core store unit 112b may fetch a store instruction for the neural core 100 and issue the store instruction. When the neural core store unit 112b provides the issued store instruction to the store buffer SB, the store buffer SB may sequentially transmit memory access requests to the store engine 113b according to the inputted order.

The load engine 113a may receive the memory access request and retrieve data via the local interconnection 200. At this time, the load engine 113a may quickly find the data by using a translation table of a physical address and a virtual address that has been used recently in the translation lookaside buffer 114. If the virtual address of the load engine 113a is not in the translation lookaside buffer 114, the address translation information may be found in another memory.

The store engine 113b may receive the memory access request and retrieve data via the local interconnection 200. At this time, the store engine 113b may quickly find the data by using a translation table of a physical address and a virtual address that has been used recently in the translation lookaside buffer 114. If the virtual address of the store engine 113b is not in the translation lookaside buffer 114, the address translation information may be found in another memory.

The load engine 113a and the store engine 113b may send synchronization signals to the L2 sync path 300. At this time, the synchronization signal may indicate that the task has been completed.

Referring to FIG. 6 again, the local memory 120 is a memory located inside the neural core 100, and may receive all input data required for the tasks by the neural core 100 from the outside and store the input data temporarily. In addition, the local memory 120 may temporarily store the output data calculated by the neural core 100 for transmission to the outside. The local memory 120 may serve as a cache memory of the neural core 100.

The local memory 120 may transmit an input activation Act_In to the activation buffer 150 via the activation LSU 140 and receive an output activation Act_Out from the activation buffer 150 via the activation LSU 140. The local memory 120 may directly transmit and receive data to and from the processing unit 160 as well as the activation LSU 140. In other words, the local memory 120 may exchange data with each of a PE array and a vector unit as described below.

The local memory 120 may be a memory associated with the neural core level, i.e., level 1 (L1). Accordingly, the local memory 120 may also be represented as an L1 memory. The L1 memory may not be shared but be a private memory of the neural core, unlike the L2 shared memory 400 and the L3 shared memory, i.e., the shared memory 2000.

The local memory 120 may transmit data such as activations or weights via a data path. The local memory 120 may exchange synchronization signals via an L1 sync path, which is a separate dedicated path. The local memory 120 may exchange synchronization signals with, for example, the LSU 110, the weight buffer 130, the activation LSU 140, and the processing unit 160 via the L1 sync path.

The weight buffer 130 may receive a weight from the local memory 120. The weight buffer 130 may transfer the weight to the processing unit 160. The weight buffer 130 may temporarily store the weight before transferring the weight.

The input activation Act_In and the output activation Act_Out may refer to input values and output values of the layers of a neural network, respectively. In this case, if there are a plurality of layers in the neural network, the output value of the previous layer becomes the input value of the next layer, and thus, the output activation Act_Out of the previous layer may be utilized as the input activation Act_In of the next layer.

The weight may refer to a parameter that is multiplied by the input activation Act_In inputted in each layer. The weight may be updated in the deep learning training stage, and may be used to derive the output activation Act_Out via the updated value in the inference stage.

The activation LSU 140 may transfer the input activation Act_In from the local memory 120 to the activation buffer 150, and the output activation Act_Out from the activation buffer 150 to the on-chip buffer. In other words, the activation LSU 140 may perform both a load task and a store task of the activation.

The activation buffer 150 may provide the input activation Act_In to the processing unit 160 and receive the output activation Act_Out from the processing unit 160. The activation buffer 150 may temporarily store the input activation Act_In and the output activation Act_Out.

The activation buffer 150 may quickly provide the activation to the processing unit 160, in particular, the PE array 163, which has a large amount of calculation, and may quickly receive the activation, thereby increasing the calculation speed of the neural core 100.

The processing unit 160 may be a module that performs calculations. The processing unit 160 may perform not only one-dimensional calculations but also two-dimensional matrix calculations, i.e., convolution operations. The processing unit 160 may receive an input activation Act_In, multiply the input activation Act_In by a weight, and then add it to generate an output activation Act_Out.

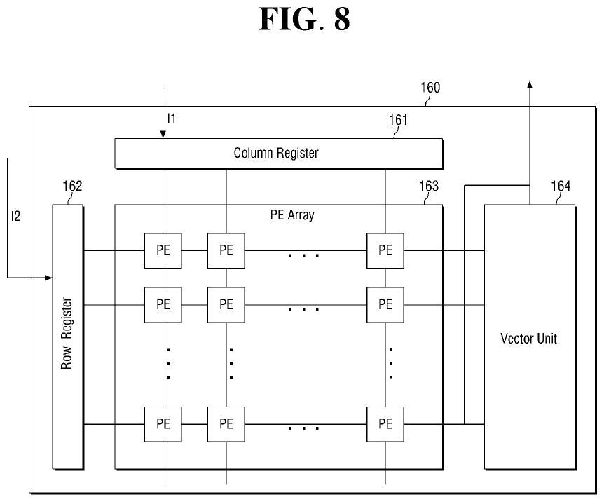

FIG. 8 is a block diagram for illustrating the processing unit of FIG. 6.

Referring to FIGS. 6 and 8, the processing unit 160 may include a PE array 163, a vector unit 164, a column register 161, and a row register 162.

The PE array 163 may receive the input activation Act_In and the weight and perform multiplication on the input activation Act_In and the weight. In this case, each of the input activation Act_In and the weight may be in the form of matrices and calculated via convolution. Through this, the PE array 163 may generate an output activation Act_Out. However, the embodiment is not limited thereto. The PE array 163 may generate any types of outputs other than the output activation Act_Out as well.

The PE array 163 may include at least one processing element PE. The processing elements PE may be aligned with each other so that each of the processing elements PE may perform multiplication on one input activation Act_In and one weight.

The PE array 163 may sum values for each multiplication to generate a subtotal. This subtotal may be utilized as an output activation Act_Out. The PE array 163 performs two-dimensional matrix multiplication, and thus, may be referred to as a 2D matrix compute unit.

The vector unit 164 may mainly perform one-dimensional calculations. The vector unit 164, together with the PE array 163, may perform deep learning calculations. Through this, the processing unit 160 may be specialized for necessary calculations. In other words, each of the at least one neural core 100 has calculation modules that perform a large amount of two-dimensional matrix multiplications and one-dimensional calculations, and thus, can efficiently perform deep learning tasks.

The column register 161 may receive a first input I1. The column register 161 may receive the first input I1, and distribute the first input I1 to each column of the processing elements PE.

The row register 162 may receive a second input I2. The row register 162 may receive the second input I2, and distribute the second input I2 to each row of the processing elements PE.

The first input I1 may be an input activation Act_In or a weight. The second input I2 may be a value other than the first input I1 between the input activation Act_In or the weight. Alternatively, the first input I1 and the second input I2 may be values other than the input activation Act_In and the weight.

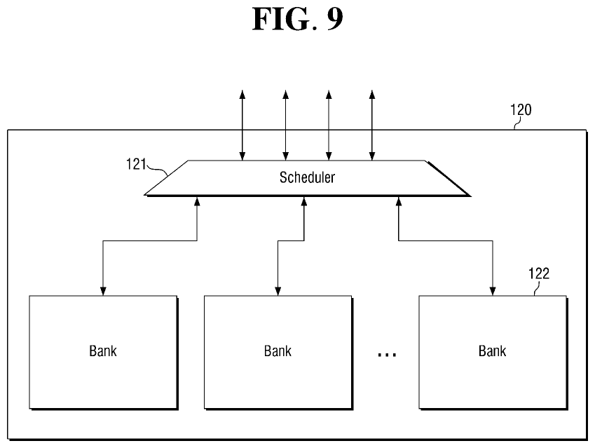

FIG. 9 is a block diagram for illustrating the local memory of FIG. 6.

Referring to FIG. 9, the local memory 120 may include a scheduler 121 and at least one local memory bank 122.

When data is stored in the local memory 120, the scheduler 121 may receive the data from the load engine 113a. In this case, the at least one local memory bank 122 may be allocated to the data in a round robin. Accordingly, the data may be stored in any one of the at least one local memory bank 122.

Conversely, when the data is loaded from the local memory 120, the scheduler 121 may receive the data from the at least one local memory bank 122 and transfer the data to the store engine 113b. The store engine 113b may store data externally via the local interconnection 200.

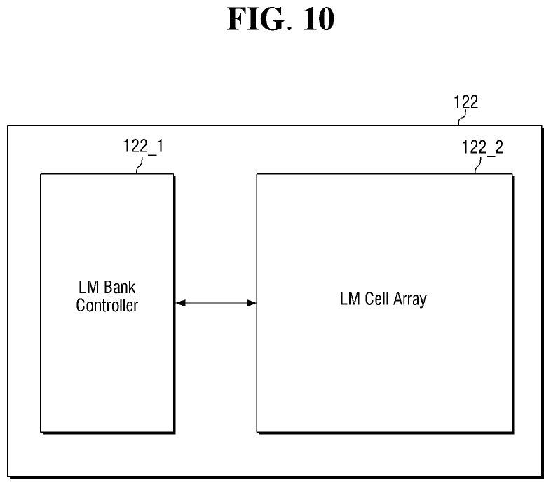

FIG. 10 is a block diagram for illustrating the local memory bank of FIG. 9.

Referring to FIG. 10, the local memory bank 122 may include a local memory bank controller 122_1 and a local memory bank cell array 122_2.

The local memory bank controller 122_1 may manage read and write operations via the addresses of data stored in the local memory bank 122. In other words, the local memory bank controller 122_1 may manage the input/output of data as a whole.

The local memory bank cell array 122_2 may be of a structure in which cells in which data is directly stored are arranged in rows and columns. The local memory bank cell array 122_2 may be controlled by the local memory bank controller 122_1.

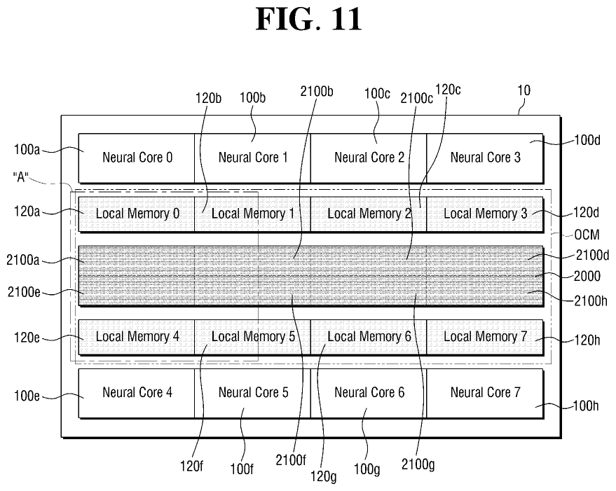

FIG. 11 is a block diagram for illustrating memory reconstruction of a processing system in accordance with some embodiments of the disclosure.

With reference to FIG. 11, the neural core SoC 10 may include first to eighth neural cores 100a to 100h and an on-chip memory OCM. Although FIG. 11 illustrates eight neural cores by way of an example, this is merely illustrative, and the number of neural cores may vary as desired.

The on-chip memory OCM may include first to eighth local memories 120a to 120h and a shared memory 2000.

The first to eighth local memories 120a to 120h may be used as private memories for the first to eighth neural cores 100a to 100h, respectively. In other words, the first to eighth neural cores 100a to 100h may correspond to the first to eighth local memories 120a to 120h, respectively.

The shared memory 2000 may include first to eighth memory units 2100a to 2100h. The first to eighth memory units 2100a to 2100h may correspond to the first to eighth neural cores 100a to 100h, respectively, and may correspond to the first to eighth local memories 120a to 120h, respectively. That is, the number of memory units may be eight, which is the same as the number of neural cores and local memories.

The shared memory 2000 may operate in either one of two on-chip memory types. In other words, the shared memory 2000 may operate in one of a local memory type or a global memory type. That is, the shared memory 2000 may implement two types of logical memories with one piece of hardware.

If the shared memory 2000 is implemented in the local memory type, the shared memory 2000 may operate as a private memory for each of the first to eighth neural cores 100a to 100h, just like the first to eighth local memories 120a to 120h. The local memory can operate at a relatively higher clock speed compared with the global memory, and the shared memory 2000 may also use a relatively faster clock when operating in the local memory type.

If the shared memory 2000 is implemented in the global memory type, the shared memory 2000 may operate as a common memory used by the first neural core 100a and the second neural core 100b together. In this case, the shared memory 2000 may be shared not only by the first to eighth neural cores 100a to 100h but also by the first to eighth local memories 120a to 120h.

The global memory may generally use a lower clock compared with the local memory, but is not limited thereto. When the shared memory 2000 operates in the global memory type, the first to eighth neural cores 100a to 100h may share the shared memory 2000. In this case, the shared memory 2000 may be connected to the volatile memory 32 of FIG. 2 via the global interconnection 6000 and may also operate as a buffer for the volatile memory 32.

At least a part of the shared memory 2000 may operate in the local memory type, and the rest may operate in the global memory type. In other words, the entire shared memory 2000 may operate in the local memory type, or the entire shared memory 2000 may operate in the global memory type. Alternatively, a part of the shared memory 2000 may operate in the local memory type, and the rest may operate in the global memory type.

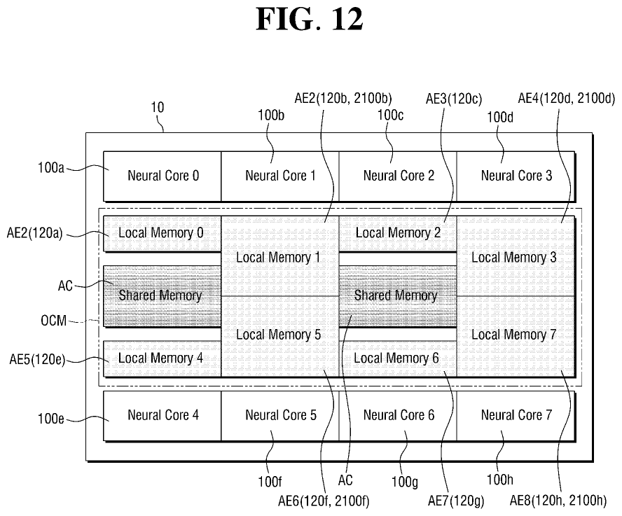

FIG. 12 is a block diagram showing an example of memory reconstruction of a processing system in accordance with some embodiments of the disclosure.

With reference to FIGS. 11 and 12, first, third, fifth, and seventh dedicated areas AE1, AE3, AE5, and AE7 for each of the first, third, fifth, and seventh neural cores 100a, 100c, 100e, and 100g may include only the first, third, fifth, and seventh local memories 120a, 120c, 120e, and 120g, respectively. Further, second, fourth, sixth, and eighth dedicated areas AE2, AE4, AE6, and AE8 for each of the second, fourth, sixth, and eighth neural cores 100b, 100d, 100f, and 100h may include second, fourth, sixth, and eighth local memories 120b, 120d, 120f, and 120h, respectively. In addition, the second, fourth, sixth, and eighth dedicated areas AE2, AE4, AE6, and AE8 may include the second, fourth, sixth, and eighth memory units 2100b, 2100d, 2100f, and 2100h. The first, third, fifth, and seventh memory units 2100a, 2100c, 2100e, and 2100g of the shared memory 2000 may be used as a common area AC.

The common area AC may be a memory shared by the first to eighth neural cores 100a to 100h. The second dedicated area AE2 may include a second local memory 120b and a second memory unit 2100b. The second dedicated area AE2 may be an area in which the second local memory 120b and the second memory unit 2100b that are separated hardware-wise operate in the same manner and operate logically as one local memory. The fourth, sixth, and eighth dedicated areas AE4, AE6, and AE8 may also operate in the same manner as the second dedicated area AE2.

The shared memory 2000 in accordance with the embodiment may convert an area corresponding to each neural core into a logical local memory and a logical global memory at an optimized ratio and may use the logical local memory and the logical global memory. The shared memory 2000 may perform the adjustment of this ratio at runtime.

That is, each neural core may perform the same task in some cases, but may perform different tasks in other cases as well. In this case, the capacity of the local memory and the capacity of the global memory required for the tasks carried out by each neural core are inevitably different each time. Accordingly, if the composition ratio of the local memory and the shared memory is fixedly set as in the conventional on-chip memory, there may occur inefficiency due to the calculation tasks assigned to each neural core.

Therefore, the shared memory 2000 of the processing device in accordance with the embodiment may set an optimal ratio of the local memory and the global memory according to calculation tasks during the runtime, and may enhance the efficiency and speed of calculation.

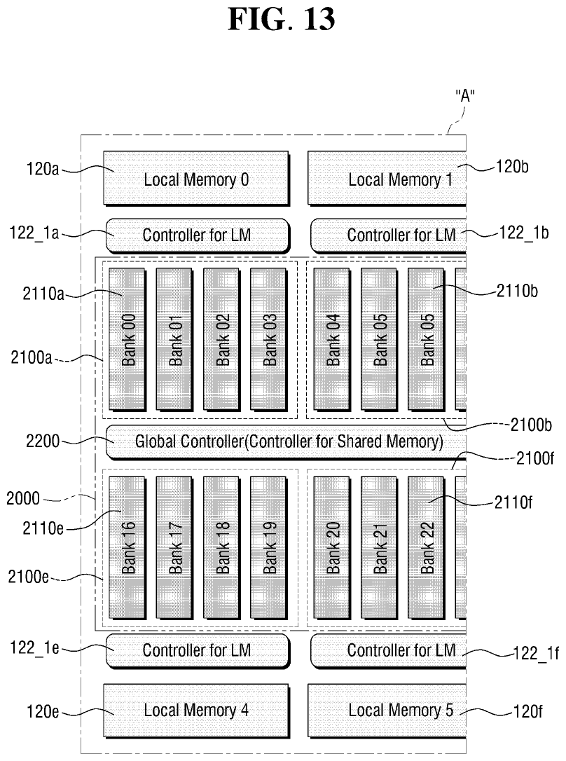

FIG. 13 is an enlarged block diagram of a portion A of FIG. 11.

Referring to FIGS. 11 and 13, the shared memory 2000 may include a first local memory controller 122_1a, a second local memory controller 122_1b, a fifth local memory controller 122_1e, a sixth local memory controller 122_1f, the first to eighth memory units 2100a to 2100h, and a global controller 2200. Other local memory controllers not shown may also be included in the embodiment, but the description thereof will be omitted for convenience.

The first local memory controller 122_1a may control the first local memory 120a. In addition, the first local memory controller 122_1a may control the first memory unit 2100a. Specifically, when the first memory unit 2100a is implemented in a logical local memory type, the first local memory controller 122_1a may control the first memory unit 2100a.

The second local memory controller 122_1b may control the second local memory 120b. Further, the second local memory controller 122_1b may control the second memory unit 2100b. In other words, when the second memory unit 2100b is implemented in the logical local memory type, the first local memory controller 122_1a may control the second memory unit 2100b.

The fifth local memory controller 122_1e may control the fifth local memory 120e. Further, the fifth local memory controller 122_1e may control the fifth memory unit 2100e. In other words, when the fifth memory unit 2100e is implemented in the logical local memory type, the fifth local memory controller 122_1e may control the fifth memory unit 2100e.

The sixth local memory controller 122_1f may control the sixth local memory 120f. Further, the sixth local memory controller 122_1f may control the sixth memory unit 2100f. In other words, when the sixth memory unit 2100f is implemented in the logical local memory type, the sixth local memory controller 122_1f may control the sixth memory unit 2100f.

The global controller 2200 may control all of the first to eighth memory units 2100a to 2100h. Specifically, the global controller 2200 may control, among the first to eighth memory unit 2100a to 2100h, memory units logically operating in the global memory type (i.e., when they do not operate logically in the local memory type).

In other words, the first to eighth memory units 2100a to 2100h may be controlled by the first to eighth local memory controllers 122_1a to 122_1h, respectively, or may be controlled by the global controller 2200, depending on what type of memory they are logically implemented in.

If the local memory controllers including the first, second, fifth, and sixth local memory controllers 122_1a, 122_1b, 122_1e, and 122_1f control the first to eighth memory units 2100a to 2100h, respectively, the first to eighth local memory controllers 122_1a to 122_1h control the first to eighth memory units 2100a to 2100h in the same manner as the first to eighth local memories 120a to 120h, and thus, can control them as the private memory of the first to eighth neural cores 100a to 100h. In some embodiments, if the i-th local memory controller controls the i-th memory unit, the i-th local memory controller controls the i-th memory unit in the same manner as it controls the i-th local memory, and thus, can control the i-th memory unit as the dedicated memory of the i-th neural core. Accordingly, the first to eighth memory units 2100a to 2100h may operate at clock frequencies corresponding to the clock frequencies of the first to eighth neural cores 100a to 100h.

Each of the local memory controllers including the first local memory controller 122_1a, the second local memory controller 122_1b, the fifth local memory controller 122_1e, and the sixth local memory controller 122_1f may include the LSU 110 of FIG. 6.

If the global controller 2200 controls at least one of the first to eighth memory units 2100a to 2100h, respectively, then the global controller 2200 may control the first to eighth memory units 2100a to 2100h as the global memory of the first to eighth neural cores 100a to 100h, respectively. Accordingly, at least one of the first to eighth memory units 2100a to 2100h may operate at a clock frequency independent of the clock frequencies of the first to eighth neural cores 100a to 100h, respectively. However, the embodiment is not limited thereto.

The global controller 2200 may connect the first to eighth memory units 2100a to 2100h with the global interconnection 6000 of FIG. 3. The first to eighth memory units 2100a to 2100h may exchange data with the off-chip memory 30 of FIG. 2 or may exchange data with the first to eighth local memories 120a to 120h, respectively, by means of the global controller 2200.

Each of the first to eighth memory units 2100a to 2100h may include at least one memory bank. The first memory unit 2100a may include at least one first memory bank 2110a. The first memory banks 2110a may be areas obtained by dividing the first memory unit 2100a into certain sizes. The first memory banks 2110a may all be memory devices of the same size. However, the embodiment is not limited thereto. FIG. 13 illustrates that four memory banks are included in one memory unit.

Similarly, the second, fifth, and sixth memory units 2100b, 2100e, and 2100f may include at least one second, fifth, and sixth memory banks 2110b, 2110e, and 2110f, respectively.

In the following, the description will be made based on the first memory banks 2110a and the fifth memory banks 2110e, which may be the same as other memory banks including the second and sixth memory banks 2110b and 2110f.

Each the first memory banks 2110a may operate logically in the local memory type or operate logically in the global memory type. In this case, the first memory banks 2110a may operate independently of the other memory banks in the first memory unit 2100a. However, the embodiment is not limited thereto.

If each memory bank operates independently, the first memory unit 2100a may include a first area operating in the same manner as the first local memory 120a and a second area operating in a different manner from the first local memory 120a. In this case, the first area and the second area do not necessarily coexist, but any one area may occupy the entire first memory unit 2100a.

Likewise, the second memory unit 2100b may include a third area operating in the same manner as the second local memory 120b and a fourth area operating in a different manner from the second local memory 120b. In this case, the third area and the fourth area do not necessarily coexist, and any one area may occupy the entire first memory unit 2100a.

In this case, the ratio of the first area to the second area may be different from the ratio of the third area to the fourth area. However, the embodiment is not limited thereto. Therefore, the ratio of the first area to the second area may be the same as the ratio of the third area to the fourth area. In other words, the memory composition ratio in each memory unit may vary as desired.

In general, in the case of the conventional neural core SoC, the on-chip memory except for high-speed local memory often included high-density, low-power SRAM. This is because SRAM has high efficiency in terms of chip area and power consumption relative to required capacity. However, with the conventional on-chip memory, the processing speed slowed down significantly inevitably in the case of tasks that require more data quickly than the predetermined capacity of the local memory, and even when the need for the global memory is not high, there is no way to utilize the remaining global memory, resulting in inefficiency.

On the other hand, the shared memory 2000 in accordance with some embodiments may be controlled selectively by any one of the two controllers depending on the cases. In this case, the shared memory 2000 may be controlled not only as a whole by a determined one of the two controllers but also independently for each memory unit or each memory bank.

Therefore, the shared memory 2000 in accordance with the embodiment may obtain an optimal memory composition ratio for calculation tasks during the runtime to perform faster and more efficient calculation tasks. In the case of a processing unit specialized in artificial intelligence, the required sizes of local memory and global memory may vary for each particular application. Moreover, even for the same application, the required sizes of local memory and global memory may vary for each layer when a deep learning network is used. In the shared memory 2000 in accordance with the embodiment, the composition ratio of the memory can be changed during the runtime even when calculation steps change for each layer, making fast and efficient deep learning tasks possible.

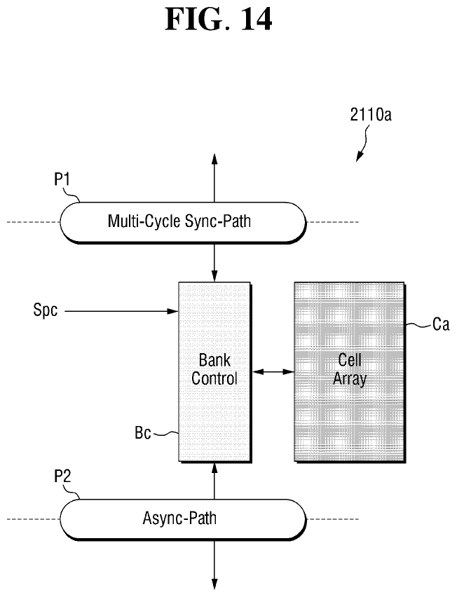

FIG. 14 is a diagram for illustrating the first bank of FIG. 13. Although FIG. 14 illustrates the first memory bank 2110a, other memory banks may also have the same structure as the first memory bank 2110a.

Referring to FIG. 14, the first memory bank 2110a may include a cell array Ca, a bank controller Bc, a first path unit P1, and a second path unit P2.

The cell array Ca may include a plurality of memory devices (cells) therein. In the cell array Ca, the plurality of memory devices may be arranged in a lattice structure. The cell array Ca may be, for example, a SRAM (static random-access memory) cell array.

The bank controller Bc may control the cell array Ca. The bank controller Bc may determine whether the cell array Ca operates in the local memory type or in the global memory type, and may control the cell array Ca according to the determined memory type.

Specifically, the bank controller Bc may determine whether to transmit and receive data in the direction of the first path unit P1 or to transmit and receive data in the direction of the second path unit P2 during the runtime. The bank controller Bc may determine a data transmission and reception direction according to a path control signal Spc.

The path control signal Spc may be generated by a pre-designed device driver or compiler. The path control signal Spc may be generated according to the characteristics of calculation tasks. Alternatively, the path control signal Spc may be generated by an input received from a user. In other words, the user may directly apply an input to the path control signal Spc in order to select optimal memory composition ratio.

The bank controller Bc may determine a path along which the data stored in the cell array Ca are transmitted and received via the path control signal Spc. The exchange interface of data may be changed as the bank controller Bc determines the path along which the data are transmitted and received. In other words, a first interface may be used when the bank controller Bc exchanges data with the first path unit P1, and a second interface may be used when the bank controller Bc exchanges data with the second path unit P2. In this case, the first interface and the second interface may be different from each other.

Also, address systems in which data are stored may vary as well. In other words, if a particular interface is selected, then read and write operations may be performed in an address system corresponding thereto.

The bank controller Bc may operate at a particular clock frequency. For example, if the cell array Ca is an SRAM cell array, the bank controller Bc may operate at the operating clock frequency of a general SRAM.

The first path unit P1 may be connected to the bank controller Bc. The first path unit P1 may directly exchange the data of the cell array Ca with the first neural core 100a. In this case, “directly” may mean being exchanged with each other without going through the global interconnection 6000. In other words, the first neural core 100a may exchange data directly with the first local memory 120a, and the first neural core 100a may exchange data via the first path unit P1 when the shared memory 2000 is implemented logically in the local memory type. The first path unit P1 may include local memory controllers including the first local memory controller 122_1a and the second local memory controller 122_1b of FIG. 13.

The first path unit P1 may form a multi-cycle sync-path. That is, the operating clock frequency of the first path unit P1 may be the same as the operating clock frequency of the first neural core 100a. The first local memory 120a may quickly exchange data at the same clock frequency as the operating clock frequency of the first neural core 100a in order to quickly exchange data at the same speed as the operation of the first neural core 100a. Likewise, the first path unit P1 may also operate at the same clock frequency as the operating clock frequency of the first neural core 100a.

In this case, the operating clock frequency of the first path unit P1 may be multiples of the operating clock frequency of the bank controller Bc. In this case, a clock domain crossing (CDC) operation for synchronizing the clocks between the bank controller Bc and the first path unit P1 is not needed separately, and thus, a delay of data transmission may not occur. Accordingly, faster and more efficient data exchange can be possible.

In FIG. 14, the operating clock frequency of the first path unit P1 may be 1.5 GHz, as an example. This may be twice the frequency of 750 MHz of the bank controller Bc. However, the embodiment is not limited thereto, and any may be possible as long as the first path unit P1 operates at integer multiples of the clock frequency of the bank controller Bc.

The second path unit P2 may be connected to the bank controller Bc. The second path unit P2 may exchange the data of the cell array Ca with the first neural core 100a not directly but via the global interconnection 6000. In other words, the first neural core 100a may exchange data with the cell array Ca via the global interconnection 6000 and the second path unit P2. In this case, the cell array Ca may exchange data not just with the first neural core 100a but also with other neural cores.

In other words, the second path unit P2 may be a data exchange path between the cell array Ca and all the processing units when the first memory bank 2110a is implemented logically in the global memory type. The second path unit P2 may include the global controller 2200 of FIG. 13.

The second path unit P2 may form an Async-Path. The operating clock frequency of the second path unit P2 may be the same as the operating clock frequency of the global interconnection 6000. Likewise, the second path unit P2 may also operate at the same clock frequency as the operating clock frequency of the global interconnection 6000.

In this case, the operating clock frequency of the second path unit P2 may not be synchronized with the operating clock frequency of the bank controller Bc. In this case, the clock domain crossing (CDC) operation for synchronizing the clocks between the bank controller Bc and the second path unit P2 may be required. If the operating clock frequency of the bank controller Bc and the operating clock frequency of the second path unit P2 are not synchronized with each other, the degree of freedom in the design of the clock domain may be relatively high. Therefore, the difficulty of hardware design is decreased, thereby making it possible to derive the hardware operation more easily.

The bank controller Bc may use different address systems in the case of exchanging data via the first path unit P1 and in the case of exchanging data via the second path unit P2. In other words, the bank controller Bc may use a first address system if via the first path unit P1 and a second address system if via the second path unit P2. In this case, the first address system and the second address system may be different from each other.

The bank controller Bc does not necessarily have to exist for each memory bank. In other words, the bank controller Bc is not a part for scheduling but serves to transfer signals, and thus, is not an essential part for each memory bank having two ports. Therefore, one bank controller Bc can control multiple memory banks. The multiple memory banks may operate independently even if they are controlled by the bank controller Bc. However, the embodiment is not limited thereto.

As a matter of course, the bank controller Bc may exist for each memory bank. In this case, the bank controller Bc may control each memory bank individually.

Referring to FIGS. 13 and 14, if the first memory unit 2100a exchanges data via the first path unit P1, the first address system may be used. If the first memory unit 2100a exchanges data via the second path unit P2, the second address system may be used. Similarly, if the second memory unit 2100b exchanges data via the first path unit P1, a third address system may be used. If the second memory unit 2100b exchanges data via the second path unit P2, the second address system may be used. In this case, the first address system and the third address system may be the same as each other. However, the embodiment is not limited thereto.

The first address system and the third address system may each be used exclusively for the first neural core 100a and the second neural core 100b, respectively. The second address system may be commonly applied to the first neural core 100a and the second neural core 100b.

In FIG. 14, the operating clock frequency of the second path unit P2 may operate at 1 GHz, as an example. This may be a frequency that is not synchronized with the operating clock frequency of 750 MHz of the bank controller Bc. In other words, the operating clock frequency of the second path unit P2 may be freely set without being dependent on the operating clock frequency of the bank controller Bc at all.

A generic global memory has used slow SRAM (e.g., 750 MHz) and a global interconnection (e.g., 1 GHz) faster than that, inevitably resulting in delays due to the CDC operation. On the other hand, the shared memory 2000 in accordance with some embodiments has room to use the first path unit P1 in addition to the second path unit P2, thereby making it possible to avoid delays resulting from the CDC operation.

Furthermore, in the generic global memory, a plurality of processing units use one global interconnection 6000, and thus, when the amount of data transfer occurs at the same time, the decrease in the overall processing speed is likely to occur. On the other hand, the shared memory 2000 in accordance with some embodiments has room to use the first path unit P1 in addition to the second path unit P2, thereby making it possible to achieve the effect of properly distributing the data throughput that could be concentrated on the global controller 2200 as well.

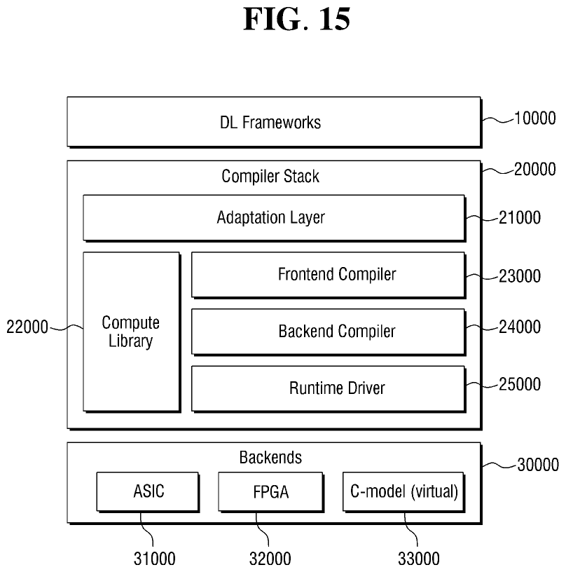

FIG. 15 is a block diagram for illustrating a processing device or a software hierarchy of the processing device in accordance with some embodiments of the disclosure.

Referring to FIG. 15, the software hierarchy of the processing device in accordance with some embodiments of the disclosure may include a deep learning (DL) framework 10000, a compiler stack 20000, and a back-end module 30000.

The DL framework 10000 may mean a framework for a deep learning model network used by a user. For example, a neural network that has finished training may be generated using a program such as TensorFlow or PyTorch.

The compiler stack 20000 may include an adaptation layer 21000, a compute library 22000, a front-end compiler 23000, a back-end compiler 24000, and a runtime driver 25000.

The adaptation layer 21000 may be a layer in contact with the DL framework 10000. The adaptation layer 21000 may quantize a neural network model of a user generated by the DL framework 10000 and modify graphs. In addition, the adaptation layer 21000 may convert the type of model into a required type.

The front-end compiler 23000 may convert various neural network models and graphs transferred from the adaptation layer 21000 into a constant intermediate representation (IR). The converted IR may be a preset representation that is easy to handle later by the back-end compiler 24000.

The optimization that can be done in advance in the graph level may be performed on such an IR of the front-end compiler 23000. In addition, the front-end compiler 23000 may finally generate the IR through the task of converting it into a layout optimized for hardware.

The back-end compiler 24000 may optimize the IR converted by the front-end compiler 23000 and convert the optimized IR into at least one binary file, each of the at least one binary file may comprise at least one binary code, enabling the binary file to be used by the runtime driver. The back-end compiler 24000 may generate at least one optimized code by dividing a job at a scale that fits the details of hardware.

The compute library 22000 may store template operations designed in a form suitable for hardware among various operations. The compute library 22000 provides the back-end compiler 24000 with multiple template operations required by hardware, allowing the optimized code to be generated.

The runtime driver 25000 may continuously perform monitoring during driving, thereby making it possible to drive the neural network device in accordance with some embodiments. Specifically, it may be responsible for the execution of an interface of the neural network device.

The back-end module 30000 may include an ASIC (application-specific integrated circuit) 31000, an FPGA (field-programmable gate array) 32000, and a C-model 33000. The ASIC 31000 may refer to a hardware chip determined according to a predetermined design method. The FPGA 32000 may be a programmable hardware chip. The C-model 33000 may refer to a model implemented by simulating hardware on software.

The back-end module 30000 may perform various tasks and derive results by using the binary code generated through the compiler stack 20000.

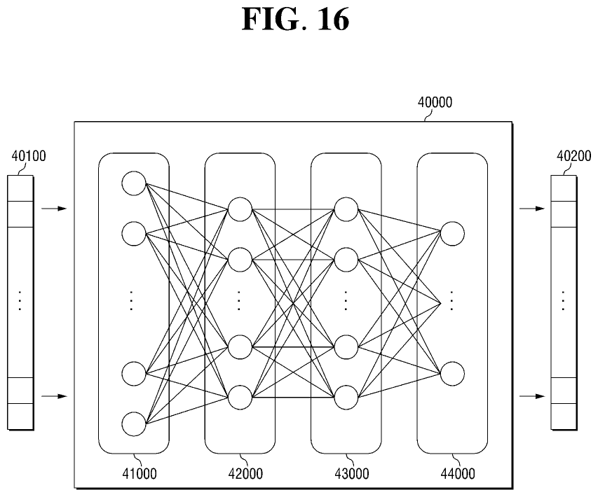

FIG. 16 is a conceptual diagram for illustrating a processing device or deep-learning calculations performed by the processing device in accordance with some embodiments of the disclosure.

Referring to FIG. 16, an artificial neural network model 40000 is one example of a machine learning model, and is a statistical learning algorithm implemented based on the structure of a biological neural network or is a structure for executing the algorithm, in machine learning technology and cognitive science.

The artificial neural network model 40000 may represent a machine learning model having an ability to solve problems by learning to reduce the error between an accurate output corresponding to a particular input and an inferred output by repeatedly adjusting the weight of the synapse by nodes, which are artificial neurons that have formed a network by combining synapses, as in a biological neural network. For example, the artificial neural network model 40000 may include any probabilistic model, neural network model, etc., used in artificial intelligence learning methods such as machine learning and deep learning.

The processing device in accordance with some embodiments of the disclosure may implement the form of such an artificial neural network model 40000 and perform calculations. For example, the artificial neural network model 40000 may receive an input image, and may output information on at least a part of an object included in the input image.

The artificial neural network model 40000 may be implemented by a multilayer perceptron (MLP) including multilayer nodes and connections between the multilayer nodes. An artificial neural network model 40000 in accordance with the embodiment may be implemented using one of various artificial neural network model structures including the MLP. As shown in FIG. 16, the artificial neural network model 40000 includes an input layer 41000 that receives input signals or data 40100 from the outside, an output layer 44000 that outputs output signals or data 40200 corresponding to the input data, and n (where n is a positive integer) hidden layers 42000 to 43000 that are located between the input layer 41000 and the output layer 44000 and that receive a signal from the input layer 41000, extract characteristics, and forward the characteristics to the output layer 44000. Here, the output layer 44000 receives signals from the hidden layers 42000 to 43000 and outputs the signals to the outside.

The learning methods of the artificial neural network model 40000 include a supervised learning method for training to be optimized to solve a problem by the input of supervisory signals (correct answers), and an unsupervised learning method that does not require supervisory signals.

The processing device may directly generate training data, through simulations, for training the artificial neural network model 40000. In this way, by matching a plurality of input variables and a plurality of output variables corresponding thereto with the input layer 41000 and the output layer 44000 of the artificial neural network model 40000, respectively, and adjusting the synaptic values between the nodes included in the input layer 41000, the hidden layers 42000 to 43000, and the output layer 44000, training may be made to enable a correct output corresponding to a particular input to be extracted. Through such a training phase, it is possible to identify the characteristics hidden in the input variables of the artificial neural network model 40000, and to adjust synaptic values (or weights) between the nodes of the artificial neural network model 40000 so that an error between an output variable calculated based on an input variable and a target output is reduced.

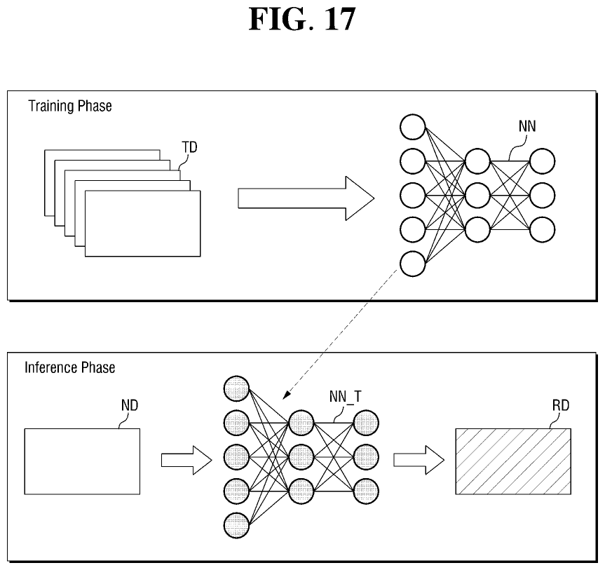

FIG. 17 is a conceptual diagram for illustrating a processing device or training and inference operations of a neural network of the processing device in accordance with some embodiments of the disclosure.

Referring to FIG. 17, the training phase may be subjected to a process in which a large number of pieces of training data TD are passed forward to the artificial neural network model NN and are passed backward again. Through this, the weights and biases of each node of the artificial neural network model NN are tuned, and training may be performed so that more and more accurate results can be derived through this. Through the training phase as such, the artificial neural network model NN may be converted into a trained neural network model NN_T.

In the inference phase, new data ND may be inputted into the trained neural network model NN_T again. The trained neural network model NN_T may derive result data RD through the weights and biases that have already been used in the training, with the new data ND as input. For such result data RD, what training data TD were used in training and how many pieces of training data TD were used in the training phase may be important.

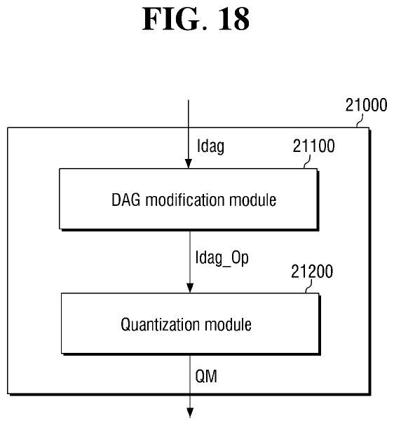

FIG. 18 is a block diagram for illustrating in detail the structure of the adaptation layer of FIG. 15.

Referring to FIGS. 15 and 18, the adaptation layer 21000 may include a DAG modification module 21100 and a quantization module 21200.

The DAG modification module 21100 may receive a neural network model, i.e., a DAG Idag, created by a user using the DL framework 10000. The DAG is a directed acyclic graph, and may be data that well represents a deep-learning task.

The DAG modification module 21100 may transform the DAG Idag into a form in which hardware can best perform and produce an optimized DAG Idag_Op. The optimized DAG Idag_Op is of the same DAG form, but may implement operations and calculation methods suitable for hardware.

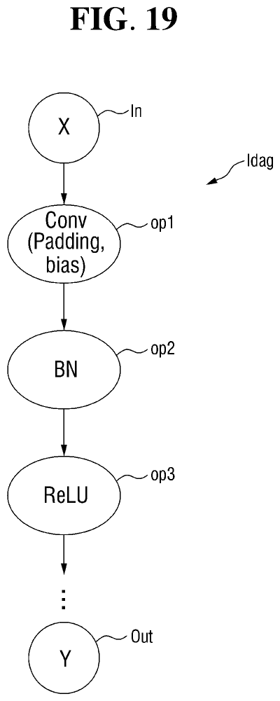

FIG. 19 is an example diagram for illustrating the DAG of FIG. 18.

Referring to FIG. 19, the DAG Idag may include at least one node and edges connecting the nodes. Each node may include an input In, an output Out, or first to third operations op1 to op3, as shown. Although FIG. 19 illustrates three operations by way of an example, the embodiment is not limited thereto.

The input In may refer to an input variable. In FIG. 19, x is designated as input variable. There may be one input variable, but may also be two or more. The output Out may refer to output variable. There may be one output variable, but may also be two or more.

The first to third operations op1 to op3 may refer to operations through which an input must go. Each operation may comprise various types of functions. For example, the first operation op1 may be an operation composed of a convolution function including padding and bias.

The second operation op2 may be composed of a function that performs batch normalization. The third operation op3 may be composed of a Rectified Linear Unit (ReLU) function. In other words, it may be an operation that rectifies a linear input.

The first to third operations op1 to op3 may be performed in sequence. The edges connecting each of the first to third operations op1 to op3 may have directionality. Specifically, the edges of the DAG Idag may be performed in sequence in the direction of the input In, the first operation op1, the second operation opt, the third operation op3, and the output Out.

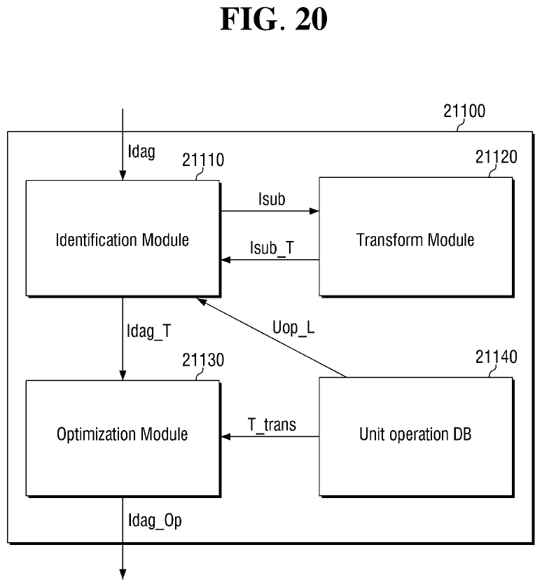

FIG. 20 is a block diagram for illustrating in detail the DAG modification module of FIG. 18.

Referring to FIG. 20, the DAG modification module 21100 may include an identification module 21110, a transform module 21120, an optimization module 21130, and a unit operation database 21140.

The identification module 21110 may receive the DAG Idag, and identify sub-graphs including unit operations and sub-graphs including non-unit operations, which are not unit operations, in the DAG Idag. In this case, the unit operations and the non-unit operations may be identified through a unit operation list Uop_L.

The identification module 21110 may receive the unit operation list Uop_L from the unit operation database 21140. Alternatively, the identification module 21110 may have the unit operation list Uop_L stored therein in advance, unlike what is illustrated.

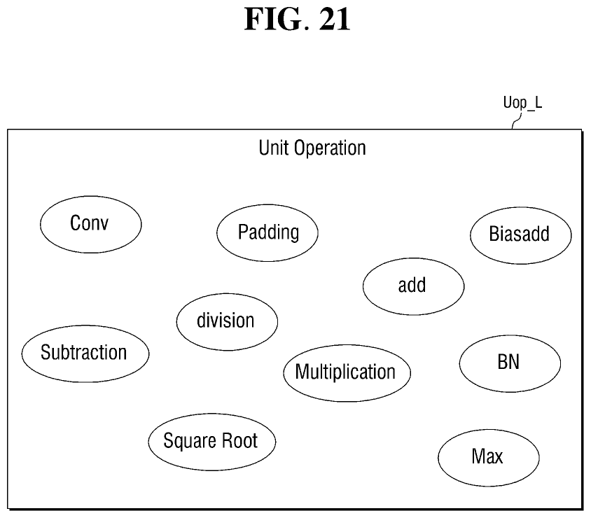

FIG. 21 is a conceptual diagram for illustrating the unit operation list of FIG. 20;

Referring to FIG. 21, the unit operation list Uop_L may be a list for defining unit operations. In FIG. 21, by way of example, at least one of the following may be included as the unit operation: a convolution operation Cony, a padding operation Padding, a bias-add operation Biasadd, an add operation add, a division operation division, a subtraction operation Subtraction, a multiplication operation Multiplication, a batch normalize operation BN, a square root operation Square Root, or a max operation Max. However, these are merely examples and the embodiment is not limited thereto.

The unit operations may be preset. In other words, it can be freely determined which operations are to be decided as the unit operations according to the characteristics of deep-learning tasks and the characteristics of hardware, in particular, the neural cores. Therefore, it may be desirable to set the unit operations to be optimal operations in order to enhance the performance and efficiency of the device.

In general, an operation may have at least one function. That is, an operation may be able to have one function, or may be able to have a plurality of functions. Therefore, if an operation has a plurality of functions, it can be partitioned into sub-operations (e.g., a first partition operation and a second partition operation) including one function. If the partition continues in this way, an operation that cannot be partitioned any further may appear, and such an operation can be defined as an atomic operation.

In other words, an atomic operation is an operation that cannot be partitioned any further, and may include, for example, four basic arithmetic operations such as an add operation add, a subtraction operation Subtraction, a multiplication operation Multiplication, and a division operation division.

As a matter of course, although there may be room for representing the above four basic arithmetic operations by other operations on the premise of bit operations, an atomic operation may refer to a smallest unit of operation performed in a deep-learning task.

As with the partition of an operation, sequential combinations of operations are also possible, and combining atomic operations can realize all other operations. Therefore, when determining unit operations, it is necessary to decide what levels of operations are to be determined as unit operations depending on the hardware characteristics (in particular, the characteristics of neural cores) and the characteristics of deep-learning tasks.

The closer the unit operations are to atomic operations, the more accurately the intention of a user can be reflected, but a number of nodes and edges may be increased, resulting in increased overhead.

On the other hand, the farther away the unit operations are from atomic operations, a number of nodes and edges may be decreased, which reduces overhead, but the more difficult it may be to clearly reflect the intention of the user. Therefore, it is necessary to decide unit operations by taking all of these factors into account.

The definition of such unit operations is performed by the unit operation list Uop_L, and the unit operation list Uop_L may be updated. In other words, it is possible to perform optimization for different deep-learning tasks through the update of the unit operation list Uop_L.

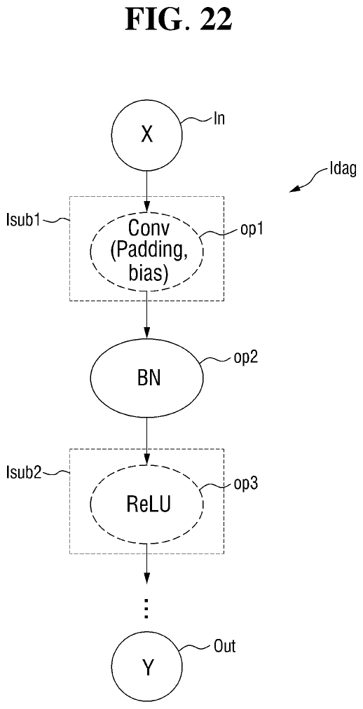

FIG. 22 is a diagram for illustrating the identification of non-unit operations of the DAG.

With reference to FIGS. 20 to 22, a first sub-graph Isub1 including the first operation op1 includes a non-unit operation, which is not a unit operation. Since the second operation op2 is a batch normalize BN operation in the unit operation list Uop_L, it is identified as a unit operation.

The third operation op3 is a non-unit operation since it is not an operation in the unit operation list Uop_L, and it can be identified by the identification module 21110 that a second sub-graph Isub2 includes a non-unit operation.

Referring again to FIG. 20, the transform module 21120 may receive at least one sub-graph Isub from the identification module 21110. The transform module 21120 may transform the sub-graph Isub to generate a transformed sub-graph Isub_T. The transform module 21120 may transmit the transformed sub-graph Isub_T back to the identification module 21110.

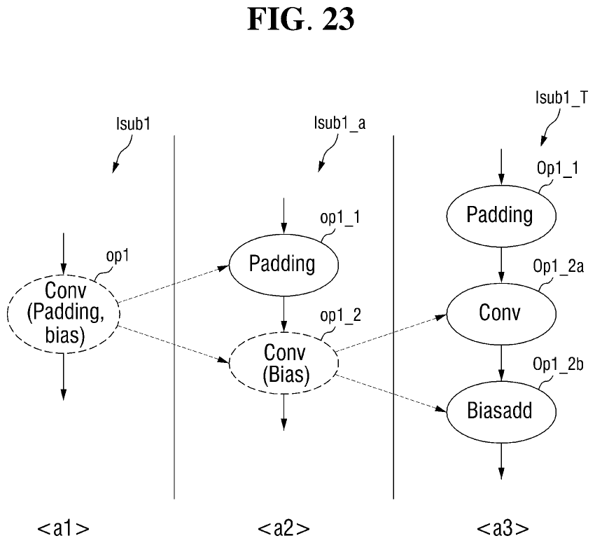

FIG. 23 is a conceptual diagram showing various implementation examples of sub-graphs.

With reference to FIGS. 20 to 23, the first sub-graph Isub1 in <a1> of FIG. 23 is implemented only by the first operation op1. The first sub-graph Isub1 may be transformed in various ways. In this case, the term ‘transform’ may mean a change in the same way that the same output is obtained when the same input is entered.

In <a2> and <a3> of FIG. 23, the first sub-graph Isub1 may be transformed into a first modified sub-graph Isub1_a and a first transformed sub-graph Isub1_T. In this case, the transformations of <a2> and <a3> of FIG. 23 are merely examples, and other methods may also be possible in any way.

The first modified sub-graph Isub1_a may include an operation 1_1 op1_1 and an operation 1_2, op1_2. The operation 1_1 op1_1 may be a padding operation. The padding operation Padding may be a unit operation since it is in the unit operation list Uop_L. The operation 1_2 op1_2 may be a convolution operation including a bias. The operation 1_2 op1_2 may be a non-unit operation that is not in the unit operation list Uop_L.

The first modified sub-graph Isub1_a may be generated by partitioning the first operation op1 of the first sub-graph Isub1 into two operations. The first modified sub-graph Isub1_a may have the same inputs and outputs as the first sub-graph Isub1.

The first transformed sub-graph Isub1_T may include the operation 1_1 op1_1, an operation 1_2a op1_2a, and an operation 1_2b op1_2b. The operation 1_2a op1_2a may be a convolution operation Cony. The operation 1_2a op1_2a may be a unit operation since it is in the unit operation list Uop_L.

The operation 1_2b op1_2b may be a bias-add operation Biasadd. The operation 1_2b op1_2b may also be a unit operation since it is in the unit operation list Uop_L.

Accordingly, all the operations included in the first transformed sub-graph Isub1_T may be unit operations. The transform module 21120 may transmit the first transformed sub-graph Isub1_T to the identification module 21110.

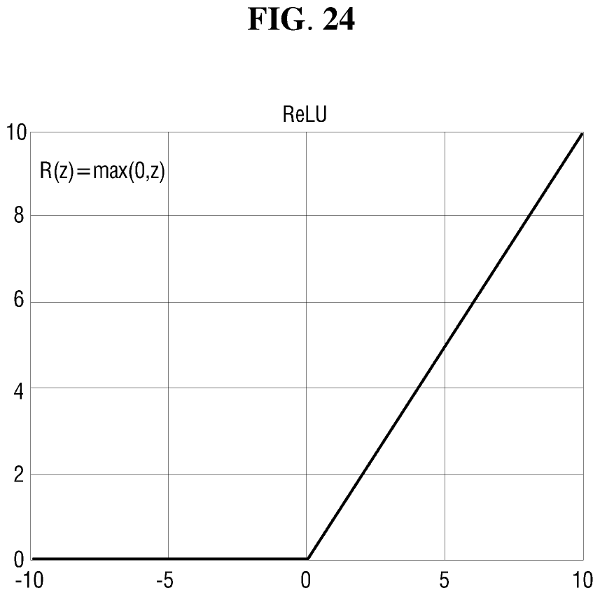

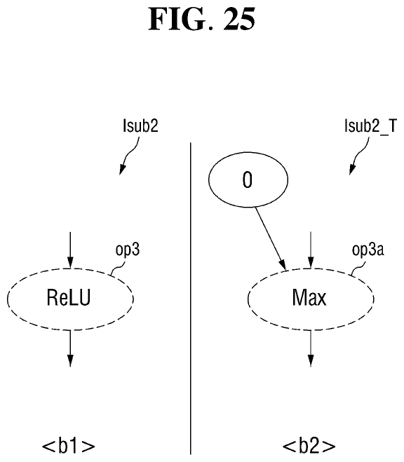

FIG. 24 is a diagram for illustrating the definition of a Rectified Linear Unit (ReLU) function, and FIG. 25 is an example diagram for illustrating various representations of ReLU operations.

Referring to FIGS. 20 to 24, the ReLU operation ReLU may be a rectification operation that displays z, which is linear straight data, as 0 when it is less than or equal to 0.

In <b1> of FIG. 25, the second sub-graph Isub2 is implemented only by the third operation op3. The second sub-graph Isub2 may also be transformed in various ways.

In <b2> of FIG. 25, the first sub-graph Isub1 may be transformed into a second transformed sub-graph Isub2_T. In this case, the transformation of <b2> of FIG. 25 is merely an example, and other methods may also be possible in any way.

The second transformed sub-graph Isub2_T may include an operation 3a op3a. The operation 3a op3a may be a max operation Max. The max operation Max is an operation that represents the greater one of two straight lines, and may have the same output as the ReLU operation ReLU when 0 (x=0) is entered as an additional input.

The max operation Max may be a unit operation since it is in the unit operation list Uop_L, and all the operations included in the second transformed sub-graph Isub2_T may be unit operations. The transform module 21120 may transmit the second transformed sub-graph Isub2_T to the identification module 21110.

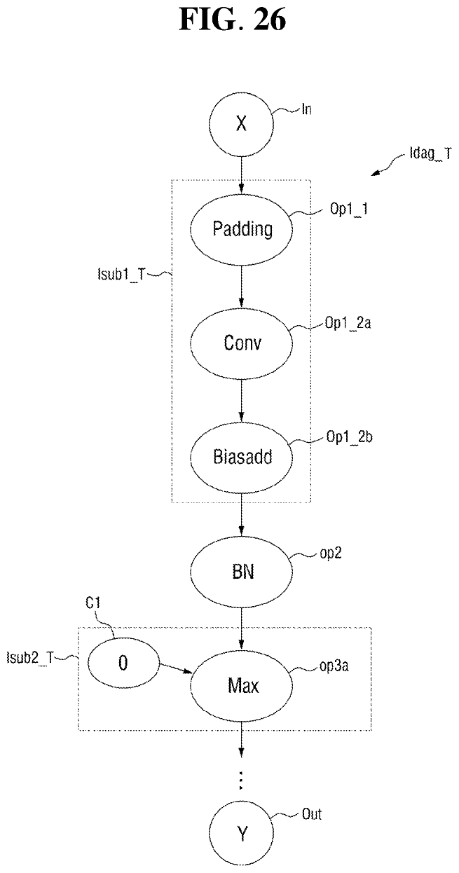

FIG. 26 is an example diagram for illustrating the transformed DAG of FIG. 20.

Referring to FIGS. 20 and 26, the identification module 21110 may receive the transformed sub-graphs Isub_T, and replace the sub-graphs Isub including the non-unit operations in the previous DAG Idag with the transformed sub-graph Isub_T. Accordingly, the identification module 21110 may generate a transformed DAG Idag_T.

The transformed DAG Idag_T may include the first transformed sub-graph Isub1_T and the second transformed sub-graph Isub2_T. The second transformed sub-graph Isub2_T may have a first constant Cl as an additional input. The transformed DAG Idag_T may have the same inputs In and outputs Out as the DAG Idag, although the number of operations may be increased. In addition, all the operations included in the transformed DAG Idag_T may be unit operations.

Referring again to FIG. 20, the optimization module 21130 may receive the transformed DAG Idag_T from the identification module 21110. The optimization module 21130 may receive a calculation method table T_trans from the unit operation database 21140. The optimization module 21130 may determine at least one calculation method for the transformed DAG Idag_T according to the calculation method table T_trans and thereby generate an optimized DAG Idag_Op.

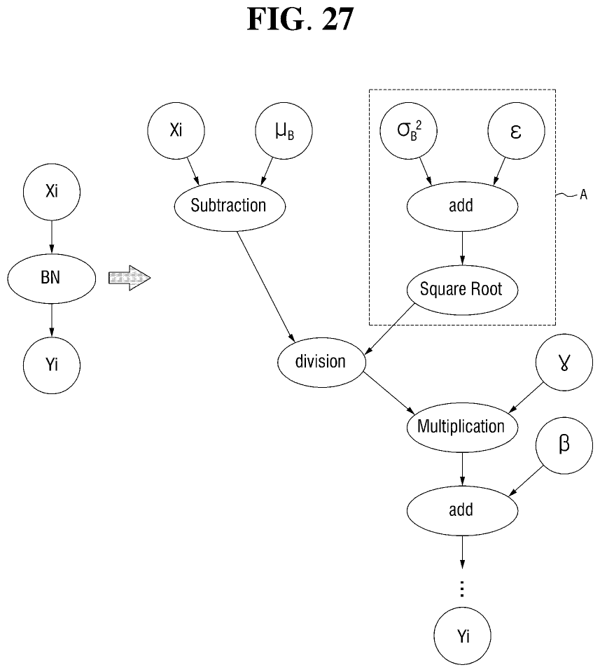

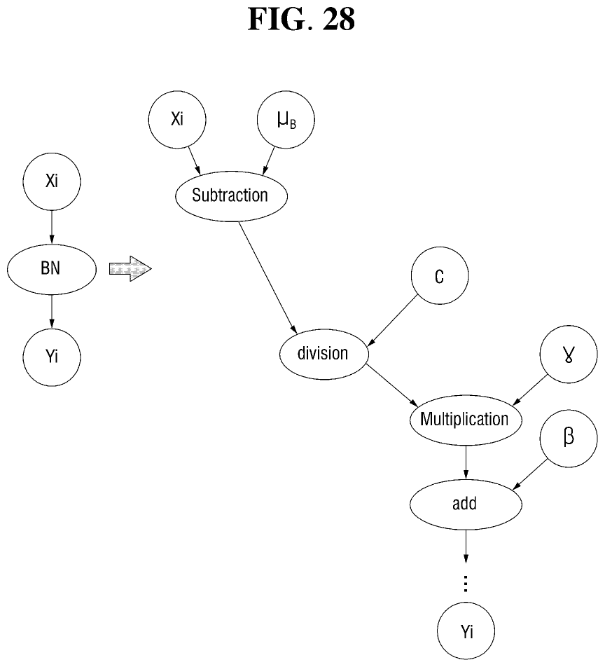

FIG. 27 is an example diagram for illustrating one representation of a calculation method for a batch normalize operation, and FIG. 28 is an example diagram for illustrating one representation of a calculation method for a batch normalize operation through constant calculation.

Referring to FIGS. 20, 27, and 28, the batch normalize operation BN can be represented by the following sequential expressions:

$${μ}_{ℬ} ← \frac{1}{m} {\sum }_{i = 1}^{m} {x}_{i}$$

$${σ}_{ℬ}^{2} ← \frac{1}{m} {\sum }_{i = 1}^{m} {( {x}_{i} - {μ}_{ℬ} )}^{2}$$

$${\hat{x}}_{i} ← \frac{{x}_{i} - {μ}_{ℬ}}{\sqrt{{σ}_{ℬ}^{2} + ϵ}}$$

$${y}_{i} ← γ {\hat{x}}_{i} + β ≡ {BN}_{γ , β} ( {x}_{i} )$$

In this case, the input may be B={x_{1 . . . m}}, and the output may be {yᵢ=BN_{γ,β}(xᵢ)}. The parameters μ_{B}, σ_{B}, ε, and γ can be given as constants.

FIG. 27 is a representation in a sub-graph of the above expressions. Referring to FIG. 27, the subtraction operation Subtraction, the add operation add, the square root operation Square Root, the division operation division, and the multiplication operation Multiplication may be used.

In this case, since σ_{B}² and ε are constants, part A may be calculated in advance. Once part A has been calculated in advance in this way, the DAG may be illustrated as shown in FIG. 28. C in FIG. 28 may be a result of calculating part A. C may be a final value that can be calculated with constants. FIGS. 27 and 28 may have the same inputs and outputs as each other, but calculation methods may be different from each other. In other words, since the numbers of the respective nodes and edges are different, the calculation method of FIG. 28 can perform calculations faster than the calculation method of FIG. 27.

Referring again to FIG. 20, the optimization module 21130 may determine calculation methods for the unit operations in the transformed DAG Idag_T with the calculation methods that have already been optimized by the calculation method table T_trans. Accordingly, the optimization module 21130 may generate an optimized DAG Idag_Op.

The unit operation database 21140 may include the unit operation list Uop_L and the calculation method table T_trans. The unit operation list Uop_L may designate unit operations at the level desired by a user, and may update the unit operation list Uop_L. Accordingly, the desired unit operations may be designated according to different deep-learning tasks, and thus high efficiency can be obtained.

The calculation method table T_trans may be preset and record an optimal calculation method for each of the unit operations. The calculation method table T_trans may set a calculation method by partitioning a unit operation into atomic operations. For example, since the padding operation Padding is an operation that adds a border including zeros to the four sides of the input, it can be partitioned into four concatenation operations. The concatenation operation may be an operation that adds a sequence of one row or one column.

The padding operation Padding can be defined as a calculation method that sequentially combines a first concatenation operation that adds a sequence consisting only of one row of zeros to above the input, a second concatenation operation that adds a column consisting only of one column of zeros to left of the input, a third concatenation operation that adds a column consisting only of one column of zeros to right of the input, and a fourth concatenation operation that adds a sequence consisting only of one row of zeros to below the input. In this case, all of the first to fourth concatenation operations may be atomic operations. However, the embodiment is not limited thereto.

The method in which the padding operation Padding is implemented may vary, in addition to the method of sequentially using the first to fourth concatenation operations. Simply put, it may be possible to implement the padding operation Padding by proceeding in the reverse order of the first to fourth concatenation operations as well.

In other words, the calculation method table T_trans can define one consistent calculation method with respect to such various calculation methods. Accordingly, the embodiment can enable consistent task performance with a calculation method optimized for hardware, and enable fast and efficient work. In addition, by performing calculations in the same manner each and every time, scheduling errors can be reduced, thereby improving the performance of the device.

Referring again to FIG. 18, the quantization module 21200 may receive the optimized DAG Idag_Op. The quantization module 21200 may quantize the optimized DAG Idag_Op and thereby generate a quantized model QM.

In the following, a DAG modification method of a processing device in accordance with some embodiments of the disclosure will be described with reference to FIGS. 20, 29, and 30. The parts overlapping with the embodiments described above will be omitted or simplified.

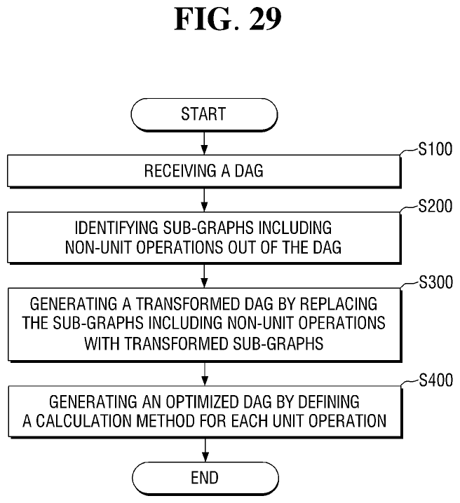

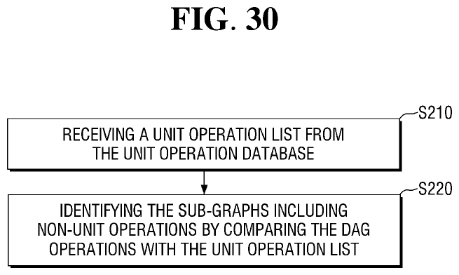

FIG. 29 is a flowchart for illustrating a DAG modification method of a processing device in accordance with some embodiments of the disclosure, and FIG. 30 is a flowchart for illustrating in detail the identifying sub-graphs of FIG. 29.

Referring to FIG. 29, at S100, a DAG is received, and at S200, sub-graphs including non-unit operations are identified out of the DAG.

In detail, referring to FIG. 30, at S210, a unit operation list is received from the unit operation database.

Specifically, referring to FIG. 20, the identification module 21110 may receive the unit operation list Uop_L from the unit operation database 21140. The unit operation list Uop_L may designate unit operations at the level desired by the user, and may update the unit operation list Uop_L. Accordingly, the desired unit operations may be designated according to different deep-learning tasks, and thus high efficiency may be obtained.

Referring again to FIG. 30, at S220, the sub-graphs including non-unit operations are identified by comparing the DAG operations with the unit operation list.

Specifically, referring to FIGS. 20 to 23, the unit operations and the non-unit operations may be identified through the unit operation list Uop_L.

Referring to FIG. 29 again, at S300, a transformed DAG is generated by replacing the sub-graphs including non-unit operations with the transformed sub-graphs.

Specifically, referring to FIG. 20, the transform module 21120 may receive the at least one sub-graph Isub from the identification module 21110. The transform module 21120 may transform the at least one sub-graph Isub to generate at least one transformed sub-graph Isub_T. The transform module 21120 may transmit the at least one transformed sub-graph Isub_T back to the identification module 21110.

The identification module 21110 may receive the at least one transformed sub-graph Isub_T, and replace the at least one sub-graph Isub including the non-unit operations in the previous DAG Idag with the at least one transformed sub-graph Isub_T. Accordingly, the identification module 21110 may generate a transformed DAG Idag_T.

Referring again to FIG. 29, at S400, an optimized DAG is generated by defining a calculation method for each unit operation.

Specifically, referring to FIG. 20, the optimization module 21130 may receive the transformed DAG Idag_T from the identification module 21110. The optimization module 21130 may receive a calculation method table T_trans from the unit operation database 21140. The optimization module 21130 may determine a calculation method for the transformed DAG Idag_T according to the calculation method table T_trans and thereby generate an optimized DAG Idag_Op.

The embodiment can optimize, in a consistent format, the DAG created freely by a user and can transform the DAG to best suit the hardware characteristics. Accordingly, the efficiency and speed of tasks can be greatly increased.

In addition, it is possible to perform optimization of the highest efficiency for each task by updating the unit operation list Uop_L while transforming the DAG Idag on a basis of unit operations.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

What is claimed is:

1. A DAG modification module comprising:
an identification module configured to receive a directed acyclic graph (DAG) as an input, identify sub-graphs including non-unit operations that are not predefined unit operations out of the DAG, and replace the sub-graphs with transformed sub-graphs to thereby generate a transformed DAG;
a transform module configured to receive the sub-graphs including the non-unit operations, transform the sub-graphs into the transformed sub-graphs including the unit operations, and transfer the transformed sub-graphs to the identification module;
a unit operation database configured to provide a unit operation list in which the unit operations are recorded to the identification module; and
an optimization module configured to receive the transformed DAG, receive a calculation method table for each of the unit operations from the unit operation database, and determine calculation methods for the unit operations of the transformed DAG to thereby generate an optimized DAG.

2. The DAG modification module of claim 1, wherein the DAG represents a deep-learning task with nodes and edges.

3. The DAG modification module of claim 1, wherein the unit operation list is updatable.

4. The DAG modification module of claim 1, wherein each of the unit operations is an atomic operation that cannot be decomposed any further.

5. The DAG modification module of claim 4, wherein the transform module partitions the non-unit operations into the unit operations and thereby generates the transformed sub-graphs.

6. The DAG modification module of claim 1, wherein the unit operations are generated by sequentially combining a plurality of partition operations.

7. The DAG modification module of claim 6, wherein the transform module generates the transformed sub-graphs by partitioning the non-unit operations into the unit operations or by combining the non-unit operations into the unit operations.

8. The DAG modification module of claim 6, wherein the unit operations comprise a convolution operation comprising padding and bias functions.

9. The DAG modification module of claim 8, wherein a first partition operation of the plurality of partition operations comprises a padding operation, and
a second partition operation of the plurality of partition operations comprises a convolution operation comprising a bias function.

10. The DAG modification module of claim 8, wherein the unit operations are generated by sequentially combining a first partition operation and a second partition operation of the plurality of partition operations with a third partition operation of the plurality of partition operations,
the first partition operation comprises a padding operation,
the second partition operation comprises a convolution operation, and
the third partition operation comprises a bias-add operation.

11. A processing device comprising:
at least one processor comprising at least one neural core; and
at least one memory configured to store data of the at least one processor,
wherein a compiler stack implemented by the at least one processor comprises:
an adaptation layer configured to receive a DAG, transform the DAG in accordance with hardware, and quantize the transformed DAG to generate a quantized model;
a front-end compiler configured to receive the quantized model and transform the quantized model into an intermediate representation; and
a back-end compiler configured to receive the intermediate representation and transform the intermediate representation into at least one binary code,
wherein the adaptation layer comprises a DAG modification module configured to receive the DAG and generate an optimized DAG using preset unit operations, and
the unit operations are at least one of several operations capable of representing sub-graphs of the DAG.

12. The processing device of claim 11, wherein the unit operations are predefined operations.

13. The processing device of claim 12, wherein each of the at least one neural core comprises:
a local memory exclusively used by each of the at least one neural core; and
an activation buffer configured to temporarily store input activations and output activations.

14. The processing device of claim 13, wherein each of the at least one neural core further comprises:
a processing unit configured to receive the input activations, perform calculations with the input activations, and thereby output the output activations, and
wherein the processing unit comprises:
a PE array configured to perform two-dimensional multiplication calculations; and
a vector unit configured to perform one-dimensional calculations.

15. The processing device of claim 13, further comprising:
a local interconnection configured to transmit data between the at least one neural core; and
an L2 sync path configured to transmit synchronization signals between the at least one neural core.

16. The processing device of claim 11, wherein the DAG modification module comprises:
an identification module configured to receive the DAG as an input, identify sub-graphs including non-unit operations out of the DAG using a unit operation list, and replace the sub-graphs with transformed sub-graphs to thereby generate a transformed DAG;
a transform module configured to receive the sub-graphs including the non-unit operations, transform the sub-graphs into the transformed sub-graphs including the unit operations, and transfer the transformed sub-graphs to the identification module; and
an optimization module configured to receive the transformed DAG, and determine calculation methods for the unit operations of the transformed DAG to thereby generate an optimized DAG.

17. The processing device of claim 16, wherein the DAG modification module further comprises a unit operation database configured to provide the unit operation list to the identification module.

18. The processing device of claim 11, wherein the unit operations are set to suit structural characteristics of the at least one neural core.

19. A DAG modification method of a processing device, comprising:
receiving a DAG including at least one sub-graph, wherein the sub-graph comprises at least one operation;
identifying whether the operation is a unit operation;
generating a transformed DAG by replacing the sub-graph including a non-unit operation that is not the unit operation with a transformed sub-graph including the unit operation; and
generating an optimized DAG by defining a calculation method for the unit operation of the transformed DAG.

20. The DAG modification method of a processing device of claim 19, wherein the identifying whether the operation is a unit operation comprises:
receiving a unit operation list; and
comparing the unit operation list with the operation.

21. The DAG modification method of a processing device of claim 19, wherein the generating an optimized DAG comprises:
receiving a calculation method table; and
generating the optimized DAG by defining a calculation method according to the calculation method table.

22. The DAG modification method of a processing device of claim 19, wherein the DAG is created with a deep-learning framework.

23. A DAG modification method of a processing device, comprising:
setting a unit operation list by predefining unit operations;
defining calculation methods for the unit operations and writing the calculation methods in a calculation method table;
receiving a DAG created with a deep-learning framework;
identifying non-unit operations that are not the unit operations out of operations of the DAG;
transforming the non-unit operations into the unit operations; and
determining the calculation methods for the unit operations.

24. The DAG modification method of a processing device of claim 23, wherein the unit operations are set according to hardware characteristics.

25. The DAG modification method of a processing device of claim 23, wherein the DAG comprises a first operation,
the first operation comprises a first function and a second function of a plurality of functions, wherein the first and second functions are atomic operation functions that cannot be partitioned any further, and
the unit operations comprise at least one of the first function or the second function.

26. The DAG modification method of a processing device of claim 23, wherein the unit operations comprise at least one of add, subtraction, multiplication, division, square root, padding, bias-add, or convolution.

27. The DAG modification method of a processing device of claim 23, wherein the determining calculation methods comprises:
identifying a first constant inputted in the unit operations; and
deriving a second constant by performing calculation with the first constant, wherein the second constant is a final value that cannot be calculated any further.

28. The DAG modification method of a processing device of claim 23, further comprises:
generating an optimized DAG for which the calculation methods have been determined; and
generating a quantized model by quantizing the optimized DAG.

29. The DAG modification method of a processing device of claim 28, further comprising:
transforming the quantized model into an intermediate representation.

30. The DAG modification method of a processing device of claim 29, further comprising:
generating at least one binary code through the intermediate representation.
